(19) United States
(12) Patent Application Publication
(10) Pub. No.: US 2009/0112928 A1
(43) Pub. Date: Apr. 30, 2009

(54) SYSTEM AND METHOD FOR IVR BASED ORDER FULFILLMENT

(75) Inventors: Chad Hoyt, Brooklyn Park, MN (US); Matt Weyland, Crystal, MN (US); Nathan Rosaaen, Hanover, MN (US)

Correspondence Address: SCHWEGMAN, LUNDBERG & WOESSNER, P.A., P.O. BOX 2938, MINNEAPOLIS, MN, 55402, US

(73) Assignee: MA Capital LLLP

(21) Appl. No.: 11/926,959

(22) Filed: Oct. 29, 2007

(51) Int. Cl. G06F 17/30

(52) U.S. Cl. 707/104.1; 707/102; 707/E17.005

(57) ABSTRACT

In one example embodiment, a system and method is disclosed as including generating a translation rule file describing a first rule to be used to translate a record definition file. An operation may then be performed that maps the record definition file, using the first rule, to generate a record definition rule file describing a second rule used to translate transaction data. Further, an operation may be performed that transforms the transaction data, using the second rule, to generate a fulfillment file. In some example embodiments, the first rule is written in an eXtensible Markup Language (XML) and describes a data type. Further, this data type may include a description of another mapping from a first data type to a second data type. In some example cases, the record definition file is written in XML, and describes a file format associated with a client.

### CROSS REFERENCE TO RELATED APPLICATIONS

This is a non-provisional patent application that is related to U.S. patent application Ser. Nos. 11/891,231 and 11/891,097 both of which are entitled “SYSTEM AND METHOD FOR IVR ANALYSIS”, and were filed on Aug. 9, 2007, and both of which are incorporated by reference in their entirety.

### COPYRIGHT

A portion of the disclosure of this document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software, data, and/or screenshots which may be illustrated below and in the drawings that form a part of this document: Copyright© 2007, Marketing Architects, Incorporated. All Rights Reserved.

### TECHNICAL FIELD

The present application relates generally to the technical field of algorithms and programming and, in one specific example, a system and method to generate a record of product sales based upon an advertisement.

### BACKGROUND

Interactive voice response is used to automate or augment many of the business processes engaged in by call centers. For example, an Inter active Voice Response (IVR)-based system may be used to guide a potential customer through a series of purchase options, help options, or other options that may be used to facilitate the purchase of a good or service. The data from this purchase of a good or service may be stored so as to assist in the fulfillment of the sale or purchase.

### BRIEF DESCRIPTION OF THE DRAWINGS

Some embodiments are illustrated by way of example and not limitation in the figures of the accompanying drawings in which:

FIG. 1 is a diagram of a system illustrating the environment for an IVR system, according to an example embodiment.

FIG. 2 is a diagram of a system, according to an example embodiment, illustrating the generation of a schema, or a record definition eXtensible Markup Language (XML) used to format a fulfillment file.

FIG. 3 is a diagram of a product list interface, according to an example embodiment, that may appear in, for example, the Fulfillment Tool Graphical User Interface (GUI).

FIG. 4 is a diagram of a product overview interface, according to an example embodiment, as may be displayed in the Fulfillment Tool GUI.

FIG. 5 is a diagram of a record definition properties interface, according to an example embodiment, that may appear within the Fulfillment Tool GUI.

FIG. 6 is a diagram of a primary record definition interface, according to an example embodiment, for a record definition container, that may be displayed in the Fulfillment Tool GUI.

FIG. 7 is a diagram of a primary record definition interface, according to an example embodiment, adding a record definition, as displayed in the Fulfillment Tool GUI.

FIG. 8 is a diagram of a field selection interface, according to an example embodiment, used to select and edit, or update an existing field that is a part of a record definition container.

FIG. 9 is a diagram of a data type interface, according to an example embodiment, as might be displayed as a part of the Fulfillment Tool GUI.

FIG. 10 is a diagram of a format interface, according to an example embodiment, that may be displayed as part of the Fulfillment Tool GUI.

FIG. 11 is a diagram of an exception handling interface, according to an example embodiment, that may be displayed as a part of the Fulfillment Tool GUI.

FIG. 12 is a diagram of an exception handling interface, according to an example embodiment, wherein a user may be able to review the specific exception that exists for a particular order.

FIG. 13 is a diagram of an exception handling interface, according to an example embodiment, showing the use of an update trigger.

FIG. 14 is a diagram of a notes expansion interface, according to an example embodiment, to display the ability to add an additional note relating to a particular selected order.

FIG. 15 is a diagram of a notes interface, according to an example embodiment, as it may appear in the Fulfillment Tool GUI.

FIG. 16 is a diagram of transaction data, according to an example embodiment.

FIG. 17 is diagram illustrating a fulfillment file, according to an example embodiment.

FIG. 18 is a diagram of a record definition XML, according to an example embodiment.

FIG. 19 is a diagram of an internal eXtensible Stylesheet Language (XSL), according to an example embodiment.

FIG. 20 is a diagram of a record definition XSL 2000, according to an example embodiment.

FIG. 21 is a block diagram of a computer system 2100, according to an example embodiment, used to generate a fulfillment file.

FIG. 22 is a flow chart illustrating a method, according to an example embodiment, to generate a fulfillment file.

FIG. 23 is a flowchart illustrating a method, according to an example embodiment, used to generate and to retrieve a fulfillment file.

FIG. 24 is a flowchart illustrating a method, according to an example embodiment, that maps the internal XSL file to a record definition XML.

FIG. 25 is a flowchart illustrating method, according to an example embodiment, that maps a record definition XSL to a transaction XML.

FIG. 26 is a flowchart illustrating a method, according to an example embodiment, used to display various interfaces.

FIG. 27 is a flowchart illustrating method, according to an example embodiment, that results from the execution of record definition operations and exception handling operations.

FIG. 28 is a flowchart illustrating a method, according to an example embodiment, used to execute record definition operations and exception handling operations.

FIG. 29 is a flowchart illustrating a method, according to an example embodiment, to retrieve orders for which an exception exists.

FIG. 30 is a flowchart illustrating a method, according to an example embodiment, used to illustrate a number of operations associated with the engine tier.

FIG. 31 is a first part of a Relational Data Schema (RDS), according to an example embodiment.

FIG. 32 is a second part of the RDS, according to an example embodiment.

FIG. 33 is a third part of the RDS, according to an example embodiment.

FIG. 34 is a diagrammatic representation of a machine in the example form of a computer system, according to an example embodiment.

### DETAILED DESCRIPTION

In the following description, for purposes of explanation, numerous specific details are set forth in order to provide a thorough understanding of example embodiments. However, it may be evident to one skilled in the art that the present invention may be practiced without these specific details.

In some example embodiments, a system and method is shown that translates transaction data received from a network appliance into a fulfillment file. This transaction data may be data relating to the sale of a good or service, where the sale is completed as a response to an advertisement. In some example embodiments, this advertisement may be a radio advertisement, while in other embodiments this advertisement may be a television or Internet-based advertisement. The network appliance may, in some example embodiments, be an IVR-switch.

In one example embodiment, in response to hearing and/or viewing an advertisement, a purchaser utilizes an IVR-based system to complete a purchase of a good or service. A record of this purchase is stored in a persistent or non-persistent data store that is part of the network appliance. Transaction data may then be periodically retrieved from the network appliance and provided to a transaction processing server. The transaction processing server may then provide the transaction data to a database server for storage and translation.

Some example embodiments may include the translation of transaction data based upon some criteria dictated by an advertiser. In one example embodiment, an internal XSL based file is generated. This internal XSL file may be a library containing certain generalized data type conversion functions. Using this internal XSL file, a user in the form of an account professional or copy writer may generate a record definition eXtensible Markup Language (XML) file. The record definition XML file may draw upon the various conversion functions outlined in the internal XSL file in creating a conversion definition for a particular advertiser. For example, a user may receive a list of formatting requirements from an advertiser that dictates how the advertiser would like to have the record of their sales (e.g., the fulfillment file) formatted. Using a Fulfillment Tool Graphical User Interface (GUI), the user may select one or more of these functions as displayed in the Fulfillment Tool GUI to dictate the format of the fulfillment file. This format may be in terms of spacing, data types, and other suitable formatting requirements. In some example embodiments, a record definition container that has at least one record definition field may be generated by the user and outlined in the record definition XML. The record definition XML may then be applied to create a record definition XSL. This record definition XSL may then be used to translate the transaction data in a fulfillment file. The fulfillment file may reflect the formatting requirement of a particular advertiser.

In some example embodiments, the generation of the fulfillment file may occur on some predefined periodic basis. The period may be some type of schedule set by the advertiser and implemented by a system administrator such that transaction data is retrieved and translated from the network appliance on a periodic basis. This period may be every 30 seconds, every day, every few days, or some other time period. In some example embodiments, it is the system administrator, or a system default value, that determines when a translation is scheduled to occur.

### Example IVR System

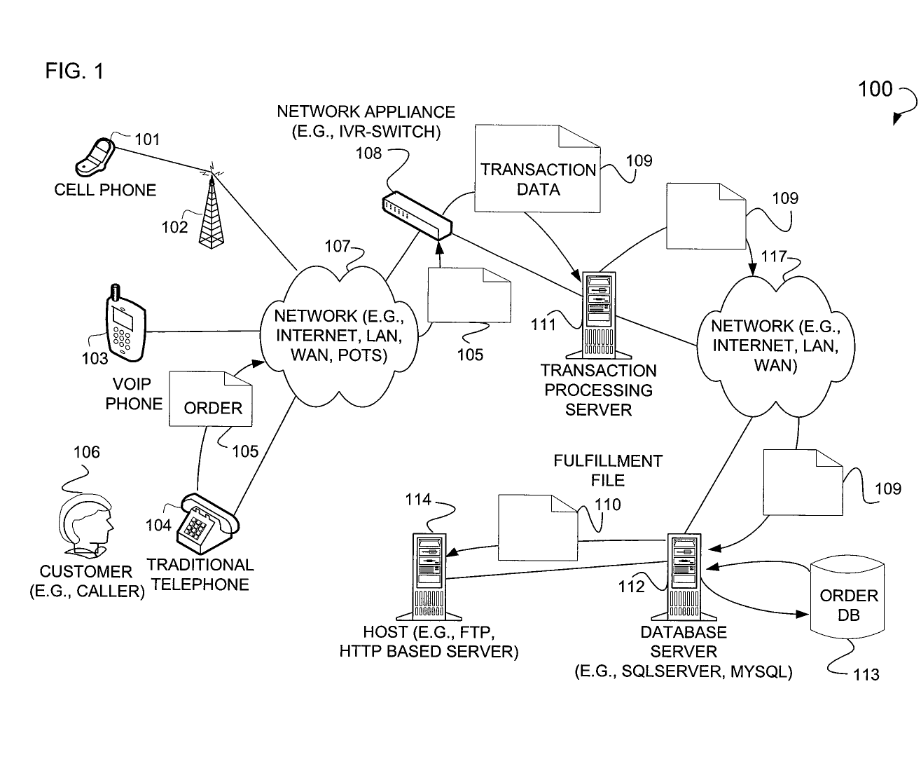

FIG. 1 is a diagram of an example system 100 illustrating a system for IVR-based order fulfillment. Shown is a cell phone 101 operably communicating with a transmitter 102. Additionally, a Voice Over Internet Protocol (IP) (VOIP) phone 103 is shown. Further, a traditional telephone 104 is shown where this traditional telephone 104 may be part of, for example, a Plain Old Telephone (POT) system. In some example embodiments the customer 106 may utilize the cell phone 101, VOIP phone 103, and/or traditional telephone 104 to place an order telephonically. Shown, for example, is a customer 106 utilizing the traditional telephone 104 to place an order 105. In some example embodiments, the cell phone 101, VOIP phone 103, and/or traditional telephone 104 may be used to communicate across a network 107 to, for example, a network appliance 108. This network appliance 108 may be an IVR switch. The network 107 may be an Internet, a Local Area Network (LAN), a Wide Area Network (WAN), or the previously referenced POT system.

In some example embodiments, the network appliance 108 may receive the order 105 and record the order 105 for later retrieval. This retrieval may take the form of, for example, transaction data 109 that is retrieved from the network appliance 108. This retrieval may be performed by, for example, a transaction processing server 111. In some example embodiments, this transaction processing server 111 may be operably connected to the network appliance 108 via a network such as, for example, the previously referenced network 107, or some other suitable network. Some example embodiments may include the transaction processing server 111 storing the transaction data 109 for further retrieval at a later predetermined time. This later predetermined time may be based upon some schedule or other mechanism used to pull this transaction data 109 off the transaction processing server 111. For example, the transaction processing server 111 may be operably connected to a database server 112 via a network 117. This network 117 may be, for example, an Internet, a LAN, or a WAN. The transaction processing server 111 may transmit the transaction data 109 across this network 117 to the database server 112. This database server 112 may store this transaction data 109 into an order database 113. This transaction data 109 may include, for example, a plurality of orders such as order 105 received from a plurality of customers such as customer 106. Once the transaction data 109 is stored into the order database 113, it may be later retrieved by, for example, an advertiser. This advertiser may use the transaction data 109 to fulfill the order 105 placed by, for example, the customer 106.

In some example embodiments, a fulfillment file 110 is provided to a host 114, where this host 114 may be, for example, a File Transfer Protocol (FTP) or Hyper Text Transfer Protocol (HTTP) utilizing server. This host 114 may pull a fulfillment file 110 from the database server 112 and ultimately from the order database 113, or this fulfillment file 110, in some example embodiments, may be pushed to the host 114. This fulfillment file 110 may be pushed based upon some predefined schedule as dictated by an advertiser running the host 114, or may be pushed based upon some other suitable basis.

In some example embodiments, the transaction data 109 is stored into the order database 113. Once stored, the transaction data 109 is retrieved by the database server 112, and a series of translations are performed on this transaction data 109, such that a fulfillment file 110 is generated. These translations may, in some example embodiments, be performed by the database server 112 or some other suitable computer system operatively connected to the order database 113 or database server 112. In some example embodiments, this database server 112 may run a database application such as Microsoft Corporation's SQL SERVER™, MYSQL™, or some other suitable database application. Further, in some example embodiments, some type of file transfer protocol may be used to transfer files from one computer system to another computer system.

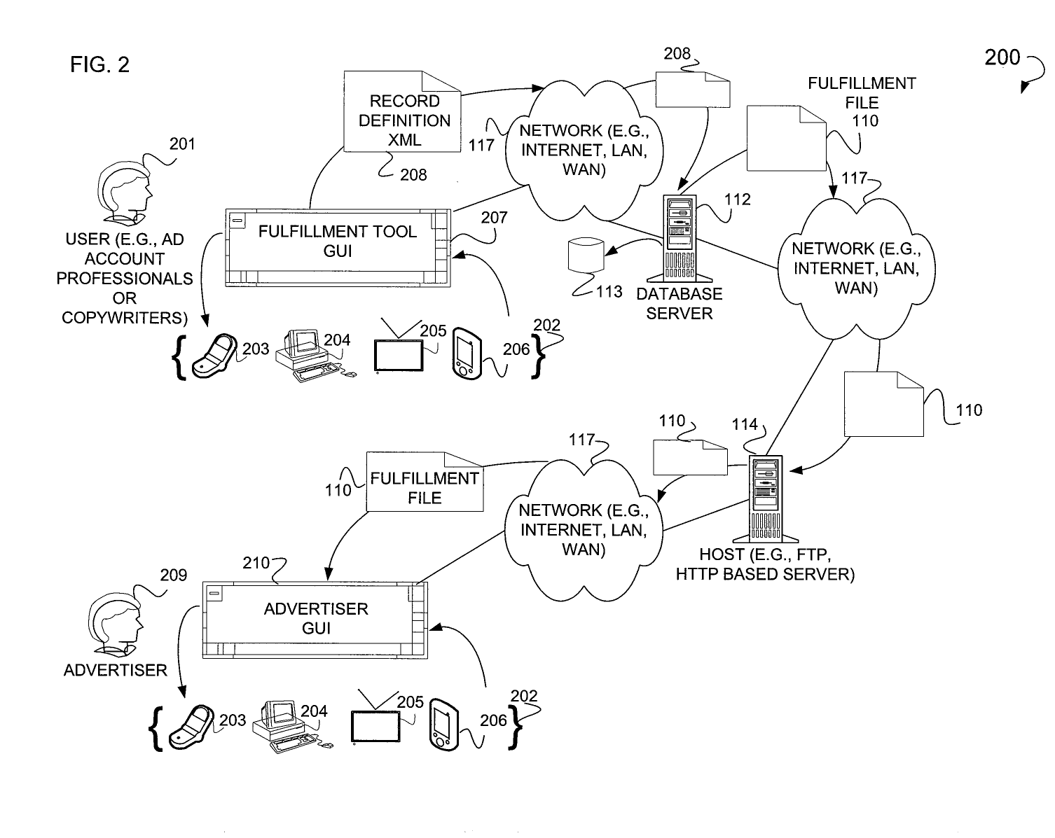

FIG. 2 is a diagram of an example system 200 illustrating the generation of a schema or, in this case, a record definition XML used to format a fulfillment file 110. Shown is a user 201 where this user 201 may be, for example, an account professional or copywriter. This user 201 may utilize one or more of a number devices 202 to generate a record definition XML 208. These devices 202 include, for example, a cell phone 203, a computer system 204, a television 205, or a Personal Digital Assistant (PDA) 206. During the course of generating this record definition XML 208, the user 201 may utilize a Fulfillment Tool GUI 207. This Fulfillment Tool GUI 207 may reside upon any one of the number of the devices 202. In one example embodiment, the Fulfillment Tool GUI 207 is a web-enabled GUI such as, for example, a browser or some other type of Hyper Text Markup Language (HTML) or XML interpreter. In some example embodiments, the Fulfillment Tool GUI 207 is a stand-alone application. The user 201, utilizing the Fulfillment Tool GUI 207, may generate a record definition XML 208. The record definition XML 208 may be transmitted across the network 117 to the previously referenced database server 112 to be ultimately stored into the order database 113. This record definition XML 208, as will be more fully described below, may be used to format the transaction data 109 that is pushed or pulled off the network appliance 108. For example, the database server 112 may take the record definition XML 208 and use it to format the transaction data 109, thus creating a fulfillment file 110. This fulfillment file 110 may be then transmitted across the network 117 to the host 114. As described above, this host 114 may transmit the fulfillment file 110 via pushing or pulling the fulfillment file 110 across the network 117 to be reviewed by an advertiser 209. In one example embodiment, the advertiser 209 may utilize an Advertiser GUI 210 that may reside on any one of a number of devices 202. In one example embodiment, the Advertiser GUI 210 is a web-enabled GUI such as, for example, a browser or some other type of HTML or XML interpreter. In still other example embodiments, the Advertiser GUI 210 does not rely upon HTML to display the data contained in the fulfillment file 110, but rather the Advertiser GUI 210 may be some type of stand-alone application that may display the fulfillment file 110. In some example embodiments, this fulfillment file 110 may be, for example, an XML file, a comma delimited file, or some other suitable type of character delimited file.

In some example embodiments, a client may utilizing the system and method illustrated herein in lieu of an advertiser. A client may be, for example, a person who engages the professional services of the system and method shown herein. The use of an advertiser 209 is for illustrative purposes within the context of the presently disclosed system and method.

In some example embodiments, the host 114 may push a fulfillment file 110 to one or more devices 202 utilized by the advertiser 209. Still, in other example embodiments, the one or more devices 202 may pull the fulfillment file 110 from the host 114. In some example embodiments, the pushing or pulling of the fulfillment file 110 may be based upon a predetermined schedule, where, based upon the schedule, the host 114 may push the fulfillment file 110 out to the one or more devices 202. Further, based upon a predetermined schedule the one or more devices 202 may pull the fulfillment file 110 from the host 114.

In some example embodiments, the concept of “pushing” refers to a sending device initiating the transfer of data such as the fulfillment file 110. The host 114 may be a sending device. In some example embodiments, the concept of “pulling” refers to the sending device transferring data in response to an initial data query sent by a receiving device such as the one or more devices 202 operated by the advertiser 209. A data query may be a Structured Query Language (SQL) based query, a Multidimensional Expression (MDX) based query, or some other suitable type of database query. These database queries may be sent using some type of protocol outlined in the Open Systems Interconnection (OSI) model or the Transmission Control Protocol/Internet Protocol (TCP/IP) protocol stack model. These protocols may include, for example, HTTP.

### Example Fulfullment Interfaces

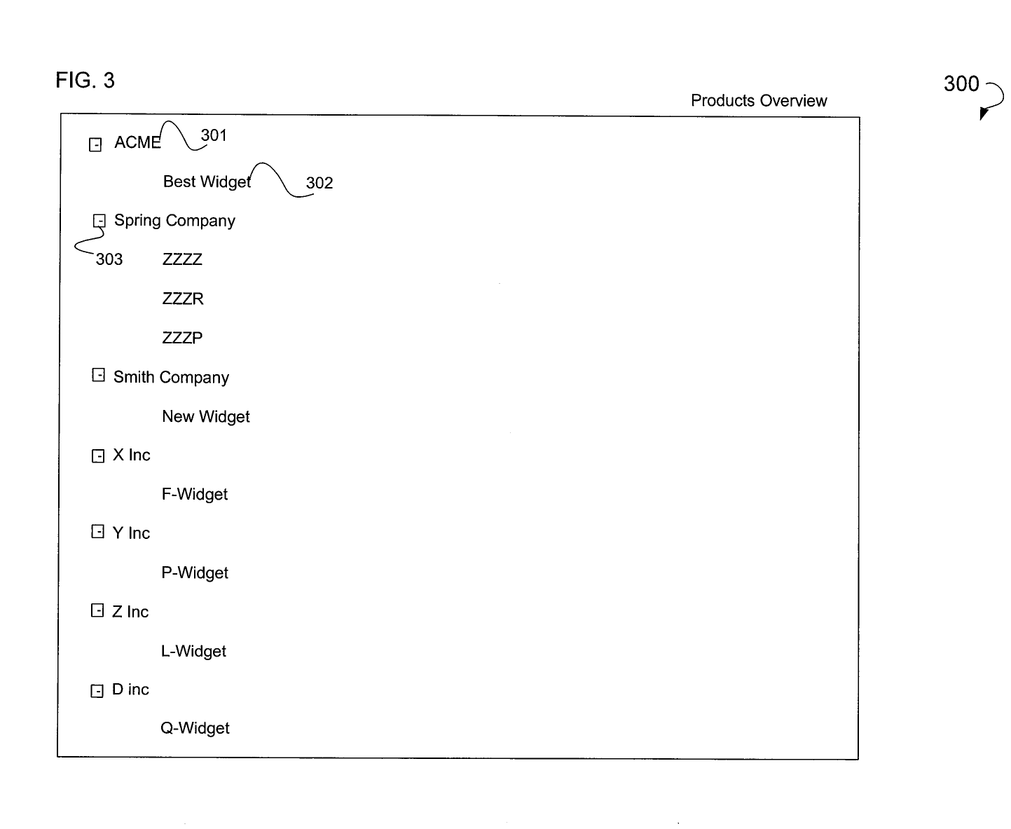

FIG. 3 is a diagram of an example product list interface 300 that may appear in, for example, the Fulfillment Tool GUI 207. In some example embodiments, this product list interface may be referenced as a product list that is displayed. Shown is a product list containing a list of clients such as advertisers, and their respective product(s), with which they may have a relation. In some example embodiments, product manufacturers and respective products may be shown within the Fulfillment Tool GUI 207 as a product list. Here, for example, an advertiser named ACME 301 is shown as is the product that they advertise, titled “best widget” 302. In some example embodiments, various types of screen objects or widgets are provided within or as a part of this product list. In some example embodiments, this screen object or widget is a GUI control. These screen objects or widgets may be expanded or contracted through an expansion or contraction widget 303.

In some example embodiments, example product list interface 300 is generated using technology including Asynchronous JavaScript And eXtensible Markup Language (XML) (collectively AJAX), Dynamic Hyper Text Markup Language (DHTML). Java Script, Java Applets, C#, VB Script, HTML, XML, or some other suitable technology used to generate a GUI and supporting logic. In some example embodiment, these technologies may be used as a stand alone application, or in conjunction with another application such as a web browser. In example embodiment, using one or more of the above technologies a frame is generated. Residing within this frame is at least one expansion or contraction widget 303. Associated with this at least one expansion or contraction widget is a advertiser name (see e.g., ACME 301) and a product associated with the advertiser name such as a title “best widget” 302. This expansion or contraction widget 303, and the supporting code upon which it relies, may be executed via, for example, a mouse over action, or some other action that makes the expansion or contraction widget 303 the focus of the user 201's activities. In certain cases, a client as opposed to an advertiser may be associated with an expansion or contraction widget.

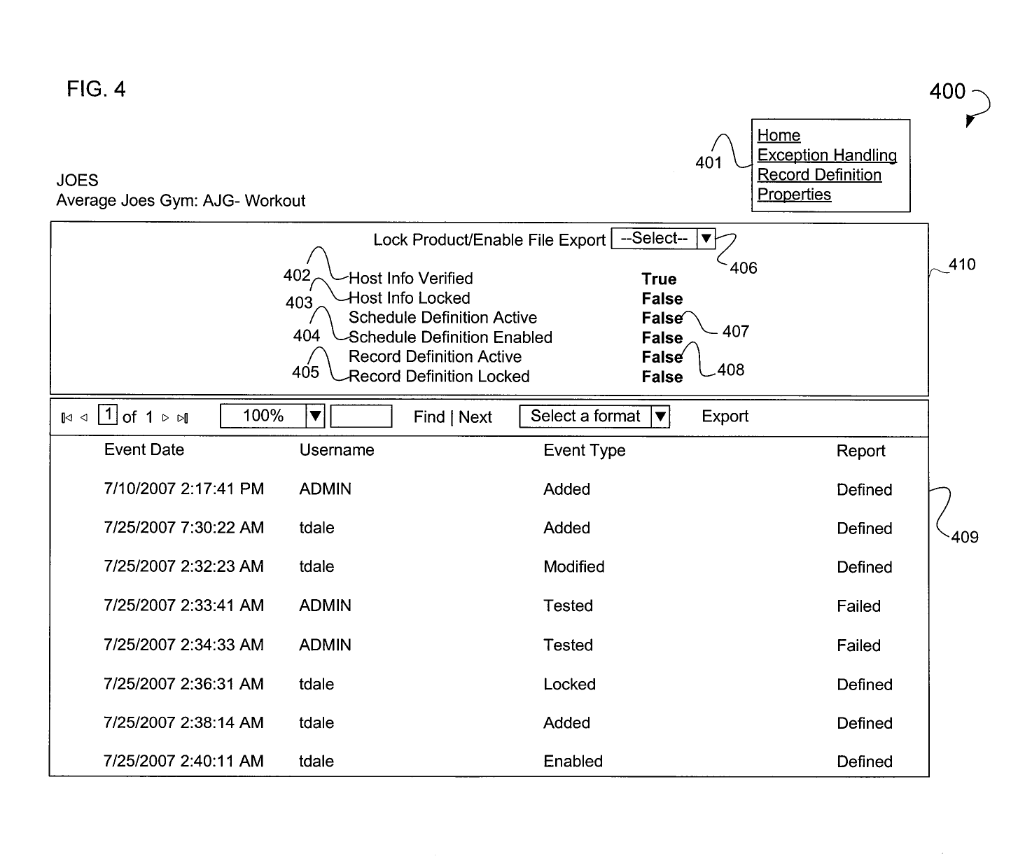

FIG. 4 is a diagram of an example product overview interface 400 as may be displayed in, for example, the Fulfillment Tool GUI 207. In some example embodiments, this product overview interface 400 is referenced as a product overview. Shown is a product overview interface 400 illustrating, for example, a summary frame 401 that contains links allowing a user 201 to navigate from one type of interface that is displayed in the Fulfillment Tool GUI 207 to another type of interface displayed in the Fulfillment Tool GUI 207. Further, a product checklist frame 410 is also shown where this product checklist frame 410 contains a number of fields denoting various privileges and attributes associated with the generation of fulfillment file 110 for a particular advertised product or service. Shown, for example, is a Lock Product/Enable File Export drop-down menu 406 that allows the user 201 to lock a particular product advertiser file or to export this advertiser file. This advertiser file may be the fulfillment file 110. Also shown are a number of fields with Boolean values. For example, a Host Info Verified field 402 is shown that instructs the user 201 as to whether or not the host information, for example the host 114, has been verified. This host information may include the network address of the host 114. Next, a Host Info Locked field 403 illustrates whether or not the information for this host 114 has been locked such that it cannot be modified. Further, a Schedule Definition Active field 407 illustrates whether or not the schedule definition for a particular product is active. Next, a Schedule Definition Enabled field 404 illustrates whether or not a particular schedule definition has been enabled. A schedule definition may dictate when, for example, the fulfillment file 110 is to be retrieved from the host 114. Further, a Record Definition Active field 408 is shown denoting whether or not the particular record definition for a particular product has been set. Also, a Record Definition Locked field 405 is shown stating whether or not this record definition for this particular product has been locked or not (e.g., whether it is subject to modification). These various fields 402 through 408 reside within the previously referenced checklist frame 410. Also shown is a frame 409 containing an event history report. In some example embodiments this event history report relates to certain types of events pertaining to a particular advertiser product. The information contained in this frame 409 may include, for example, an event date, a user name related to the event, if applicable, an event type, and whether or not a report was generated.

In some example embodiments, a number of Boolean values are represented in the fields 402 through 405, and the fields 407 through 408. In one example embodiment, a dummy file (e.g., a file containing pseudo data) may be sent to the host 114 to verify information regarding the host 114. This information may include making sure the host 114 is operating (see field 402). Additionally, in some example embodiments, a test may be performed to ensure that information regarding the host 114 is locked. This information may include, network address (e.g., Internet Protocol (IP), Media Access Control (MAC)) information regarding the location of the host 114.

Further, in some example cases, a plurality of schedules may exist for a particular product being advertised. These schedules may dictate when a particular fulfillment file 110 may be pulled from or pushed by the host 114 to the one or more devices 202. In some example embodiments, as denoted by Schedule Definition Active field 407, a schedule may or may not be active. Here shown, no schedule is active. Further, as denoted by Schedule Definition Enabled field 404, no schedules are enabled, and a schedule has not been provided.

In some example embodiments, a Record Definition Active field 408 denotes whether a record definition is active. Where a record definition is active, it may mean that a record definition has been created for a particular record. This record definition, in some example embodiments, may be a record definition container. Here the value for Record Definition Active field 408 is set to false, meaning that no record definition exists for the product as advertised. In example cases where the record definition is locked (e.g., Record Definition Locked field 405 has a Boolean set to false), the record definition container cannot be modified. In some example embodiments, the value in Record Definition Locked field 405 is set to true prior to the generation of the fulfillment file 110.

Some example embodiments may include a primary and secondary record definition for the same advertised product. In example cases where a primary and secondary record definition exist, separate fields 402 through 405, and 407 through 408 may exist for the secondary record definition.

In some example embodiments, product overview interface 400 is generated using technology including AJAX, DHTML, Java Script, Java Applets, C#, VB Script, HTML, XML, or some other suitable technology used to generate a GUI and supporting logic. In some example embodiment, these technologies may be used as a stand alone application, or in conjunction with another application such as a web browser. In example embodiment, using one or more of the above technologies a plurality of frames are generated. Residing within at least one of these frames (e.g., the product checklist frame 410) are the various fields 402 through 405, 407 through 408, and the Lock Product/Enable File Export drop-down menu 406. Further, a second frame (e.g., the frame 409) may be generated that contains an event history report may be generated using the above technologies.

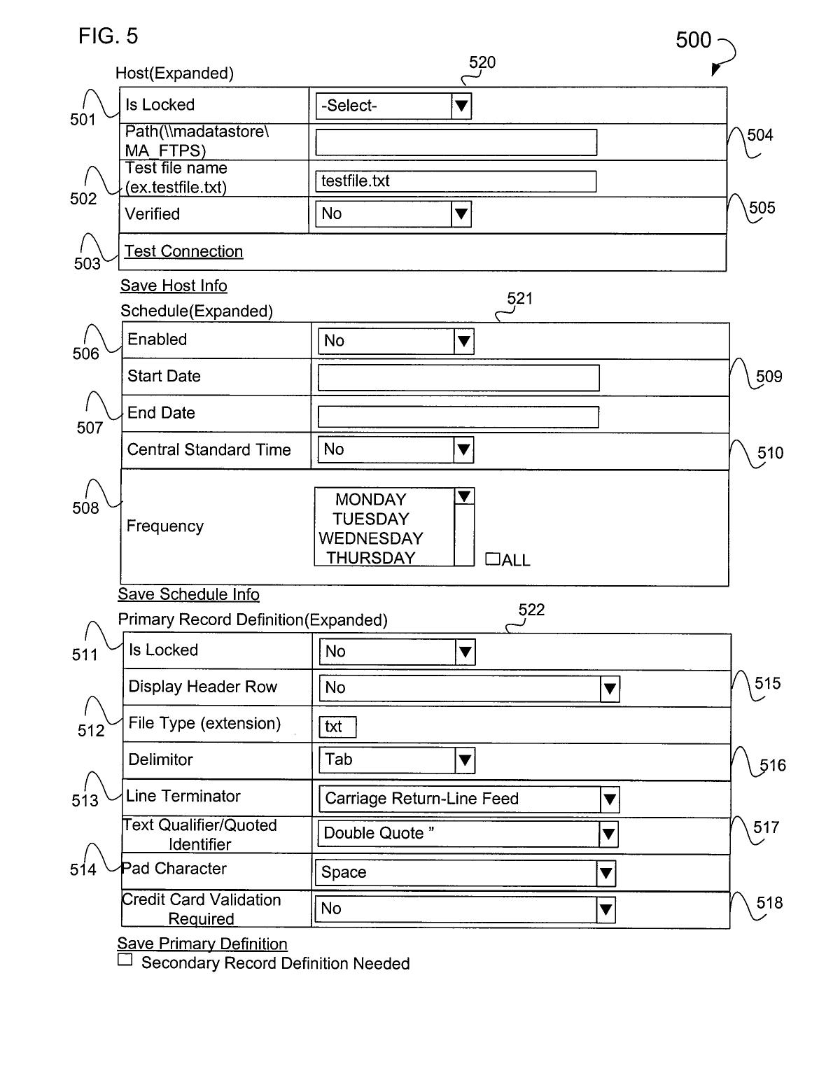

FIG. 5 is a diagram of an example record definition properties interface 500 that may appear, for example, within the Fulfillment Tool GUI 207. Shown is a record definition properties interface 500 that contains various fields that allow a user 201 to set various record definition properties for a particular advertiser such as the advertiser 209. These record definition properties may be then utilized to format the transaction data 109, and to ultimately generate a fulfillment file 110.

Some example embodiments may include a field 501 that allows the user 201 to set whether or not the record definition file will be locked. Next, a field 504 is shown that allows the user 201 to set the location (e.g., a directory path within a computer file system) of the record definition file. Also, a field 502 is shown that allows the user 201 to name the record definition file containing the record definition properties. A field 505 is shown that contains a drop-down menu allowing the user 201 to determine whether or not a record definition file has been verified or not. In some example embodiments, verification may mean, for example, that the advertiser 209 has reviewed the record definition file. Also, a field 503 is shown that allows the user 201 to establish a test connection with the file that has been created so as to test the record definition file prior to its implementation. A field 506 is shown that allows a user 201 to set a schedule based upon which the transaction data 109 may be processed using the record definition XML 208, or a record definition XSL file. In some example embodiments, “processed” may mean, for example, that the transaction data 109 may be retrieved from the network appliance 108 based upon a schedule. Once retrieved, the transaction data may be translated. A field 509 is also shown that allows the user 201 to set a start date for a scheduled retrieval. Additionally, a field 507 is also shown that allows a user 201 to set an end date for a scheduled retrieval. A field 510 is shown that allows a user 201 to set the time zone for the particular retrieval time. This time zone may be, for example, Central Standard Time or some other suitable time zone. Further, within this field 510, a drop-down menu is shown that allows the user 201 to denote with a Boolean value as to whether or not the particular referenced time zone is correct (i.e., to determine whether or not, for example, CST is correct). Also shown is a field 508 that allows the user 201 to determine the frequency with which a piece of transaction data 109 is to be retrieved from the network appliance 108. In some example embodiments, these various fields 506 through 510 may be used to set a schedule for retrieval of a fulfillment file 110 from a database server 112. Further, in some example embodiments, these various fields 506 through 510 may be used to set a schedule for retrieval of a fulfillment file 110 from the host 114.

Some example embodiments may include a field 511 that is used to determine whether the primary record definition should be locked. Next, a field 515 is shown that denotes whether or not a header row should be displayed. With regard to fields 511 and 515, in some example embodiments, a drop-down menu containing a Boolean value may be used to denote whether or not a primary record definition is locked. Further, the field 515 may be used to determine whether or not a header row should be displayed. Also shown is a field 512 that allows a user 201 to denote the file type for a particular record definition. Here, for example, the file type is a text file (e.g., TXT). In some other example embodiments, a Comma Separated Value (CSV) file may be used and denoted in the field 512 as a CSV file. Further, a field 516 is shown that contains a delimiter value which here is set to tab. In some example embodiments, a text delimiter may be, for example, a space, period, comma, semicolon, colon, or some other suitable character. A field 513 is also shown that is used to denote what constitutes a line terminator within a file, or a particular file type. Here, for example, a drop-down menu is displayed that denotes that a Carriage Return Line Feed (CRLF) may be used to denote a line termination. A field 517 is also shown that is used to denote a text qualifier, or a coded identifier. Here, for example, a dropdown menu containing a reference to double quote is used. Some other suitable text qualifier may be used such as, for example, a single quote. Further, a field 514 is shown that is used to denote what constitutes a pad character. Here, for example, a drop-down menu is shown containing a space. In some example embodiments, the space may be used as a pad character within a textbox, whereas, in other example embodiments, some other suitable character may be used to pad a particular textbox. A field 518 is also shown that relates to credit card validation. Here, for example, a drop-down menu is shown containing a Boolean value used to denote whether or not credit card validation is required with respect to a particular record definition (e.g., that credit card verification may be required for a particular record definition).

In some example embodiments, the record definition properties interface 500 is generated using technology including AJAX, DHTML, Java Script, Java Applets, C#, VB Script, HTML, XML, or some other suitable technology used to generate a GUI and supporting logic. In some example embodiment, these technologies may be used as a stand alone application, or in conjunction with another application such as a web browser. In example embodiment, using one or more of the above technologies a plurality of frames are generated. For example, a frame 520 is generated that contains a plurality of the above referenced fields (e.g., fields 501 through 505). A second frame 521 is generates that contains a plurality of fields (e.g., 506 through 510). A third frame 522 is generated that contains a plurality of fields (e.g., 511 through 518).

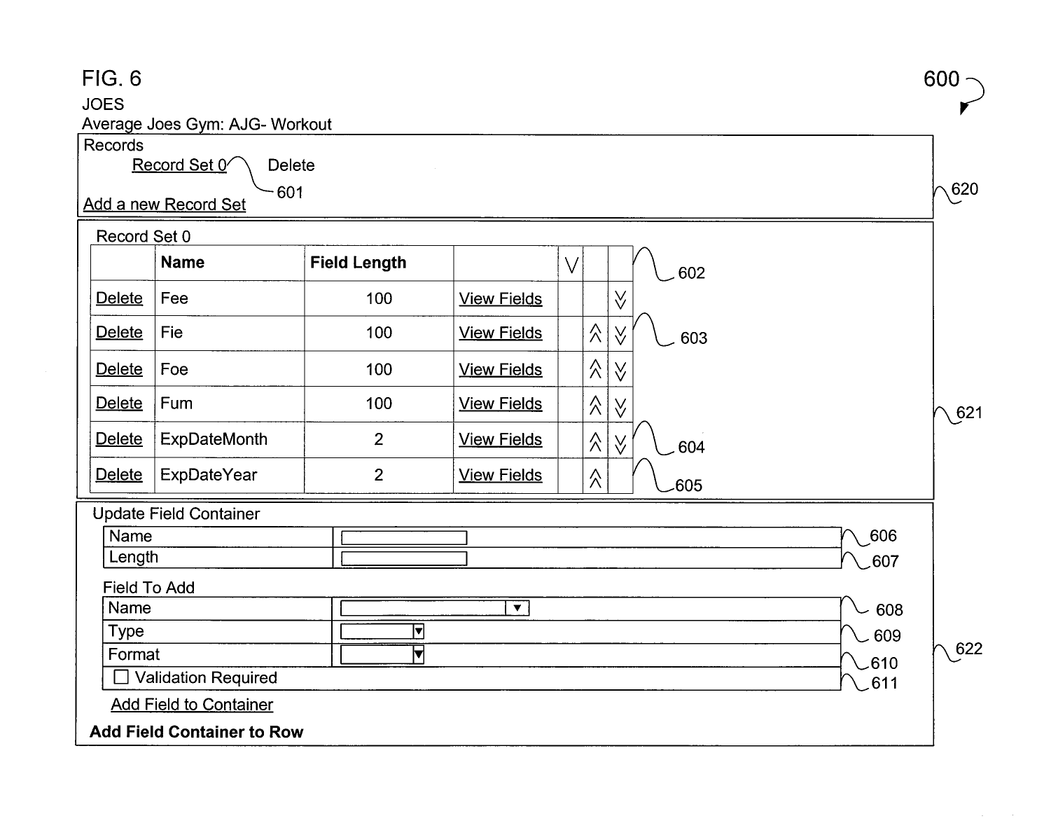

FIG. 6 is a diagram of an example primary record definition interface 600 for a record definition container that may be displayed in the Fulfillment Tool GUI 207. Shown is a record set field 601 wherein the record set is denoted to be set to zero. In some example embodiments, this field 601 may denote a record container defining the formatting for multiple records, as a part of an output file, wherein the value contained in this field 601 may be set to zero, one, two, three, or some other value relating to the number of records. Also shown is a frame 602 relating to particular selected record containers with multiple fields for each container. Here, for example, the selected record container is displayed. Contained within the selected record container are a number of fields such as, for example, field 603. This field 603 denotes a particular name of a record definition and the length of the field associated with this record definition. Further, a field 604 is shown denoting a particular record definition and the length of the field associated with this record definition. Here this record definition is the expiration day and month. Also a field 605 is shown relating to an expiration date for the year. Through using various up and down buttons, as displayed within one of these fields (e.g., 603, 604, or 605), the record definition may be moved up or down such that the formatting information relating to this record definition may be applied to the transaction data 109 coming off of the network appliance 108. Also shown is an update field container frame 622 containing a number of additional fields. This update field container frame 622 may be used to update a record definition container and the record definitions contained therein. Further, in some example embodiments, this update field container frame 622 may be used to add additional fields. These fields as illustrated in, for example, or as a part of, for example, fields 603, 604, and 605, may be added to or edited using the various update record definition containers, or add field to containers fields.

In some example embodiments, a field 606 is shown to name a particular container. A field 607 is shown to determine the length of this container wherein this length of container is in terms of characters. With regard to adding a field, a field 608 is shown to name the container that is to be added. A field 609 is shown to denote the type of record definition container to be added. A field 610 is shown to denote the format of the record definition container to be added. Additionally, a field 611 is shown to denote whether or not validation may be required when utilizing this record definition container. This validation may include, for example, credit card validation or the use of some other uniquely identifying information to denote the identity of a particular customer 106 making an order.

In some example embodiments, a record container, and record definitions contained therein, may be used to format each row in a file based upon the requirements of the advertiser 209. These requirements may be described in the record definition XML 208. Amongst others things, the field length may be dictated by the advertiser 209 based upon their needs.

In some example embodiments, primary record definition interface 600 is generated using technology including AJAX, DHTML, Java Script, Java Applets, C#, VB Script, HTML, XML, or some other suitable technology used to generate a GUI and supporting logic. In some example embodiment, these technologies may be used as a stand alone application, or in conjunction with another application such as a web browser. In example embodiment, using one or more of the above technologies a plurality of frames are generated. For example, a frame 620 is generated that contains the record set field 601. A frame 621 may also be generated that contains a plurality of fields (e.g., 602 through 605). A frame 622 may be generated that contains fields such as fields 606 through 611.

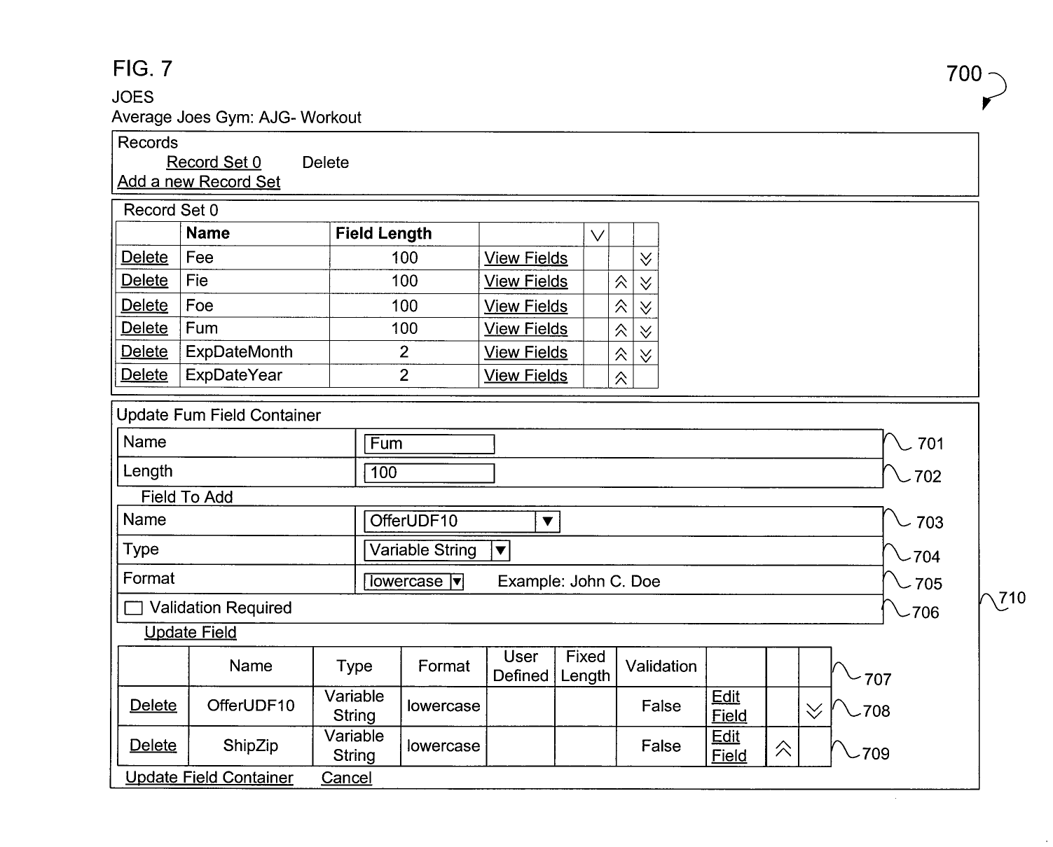

FIG. 7 is a diagram of an example primary record definition interface 700 adding a record definition, as it may be displayed in the Fulfillment Tool GUI 207. This adding of a record definition may be referenced as an add mode. This primary record definition interface 700 allows the user 201 to update an existing field by updating the specific data types utilized to format the transaction data 109. Shown is a field 701 containing the name of the field to be updated. Also shown is a field 702 containing the length of this field to be updated. Here, for example, field 701 contains the record definition container's name, which is “Fum,” and the length of the record definition container, which here is set to 100 (e.g., 100 characters). Also shown is a field 703 containing a name of a particular field that is to be added to the record definition container “Fum.” Here, for example, the name of the field to be added to the record definition container Offer EDF10. In some example embodiments, this name can be manually determined by the user 201, whereas in another example embodiment this can be automatically generated through the use of a default name. Also shown in the “Fum” record definition container frame is a field 704 relating to the particular data type that is going to be used to format the field to be added. This data type may be, for example, a string, an integer, a float, or some other suitable data type. Further, a field 705 is shown containing a format description for the particular field that is going to be added to the record definition container. Here, for example, a drop down menu is displayed that allows for the formatting of the data type disclosed in field 704 to be formatted in lower case. A field 706 is also shown containing a checkbox used to denote whether validation is required for a particular set of data provided to the record definition container.

In some example embodiments, a number of fields are shown that list source fields to create an output field for a fulfillment file 110. For example, a frame 707 is shown that contains a field 708. This field 708 denotes a name of the field to be added, the variable type of this field, the format of the field to be added, and whether validation is required. Also shown is a field 709 that contains a name of a field, a type of variable used to associate with the field, and the format of this type or variable. In some example embodiments, types of variables refer to various types of data types as is known in the art.

Some example embodiments may include an add mode as shown in FIG. 7. This add mode may allow the user 201 to add fields to a record container. Once the add mode is executed, in some example embodiments, a new record definition XML 208 may be generated as well as a record definition XSL file. In some example embodiments, a screen object or widget may be implemented so as to reposition a field or fields in a record definition. In example cases where a field is repositioned, a new record definition XML 208 may be generated as will a record definition XSL file.

In some example embodiments, primary record definition interface 700 is generated using technology including AJAX, DHTML, Java Script, Java Applets, C#, VB Script, HTML, XML, or some other suitable technology used to generate a GUI and supporting logic. In some example embodiment, these technologies may be used as a stand alone application, or in conjunction with another application such as a web browser. In example embodiment, using one or more of the above technologies a plurality of frames are generated. For example, a frame 710 is generated that contains a number of fields 701 through 709.

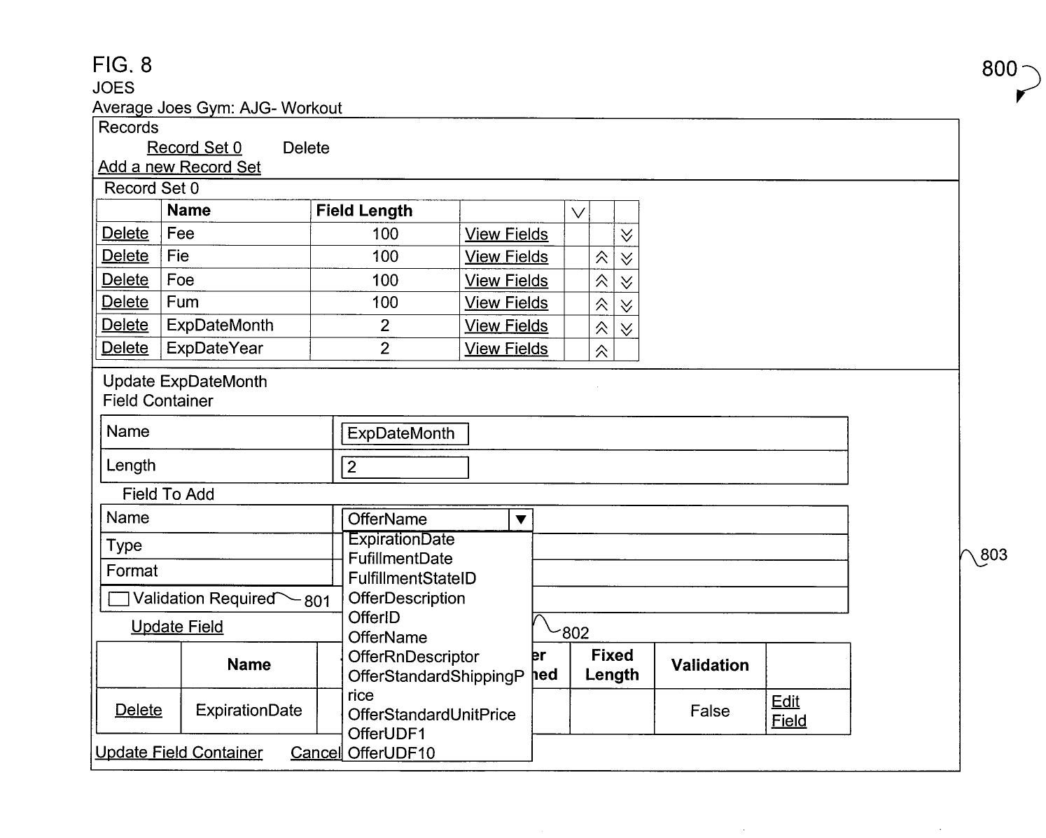

FIG. 8 is a diagram of an example field selection interface 800 used to select and edit or update an existing field that is a part of a record definition container. In some example embodiments, this field selection interface 800 may be used in conjunction with the field 703. Shown is a drop-down menu 802 that is part of a name field, wherein a series of name fields may be selected from to be added to the record definition container. These names may include, for example, expiration date, fulfillment date, fulfillment state ID, offer description, offer ID, and/or some other suitable field name. Also shown is a validation checkbox 801 that is used to denote whether or not validation is required for the data and their particular field. In some example embodiments, validation includes determining whether data should be checked for the purposes of exception handling, or some other suitable purpose.

In some example embodiments, field selection interface 800 is generated using technology including AJAX, DHTML, Java Script, Java Applets, C#, VB Script, HTML, XML, or some other suitable technology used to generate a GUI and supporting logic. In some example embodiment, these technologies may be used as a stand alone application, or in conjunction with another application such as a web browser. In example embodiment, using one or more of the above technologies a plurality of frames are generated. For example, a frame 803 is generated that contains the validation checkbox 801, and drop-down menu 802.

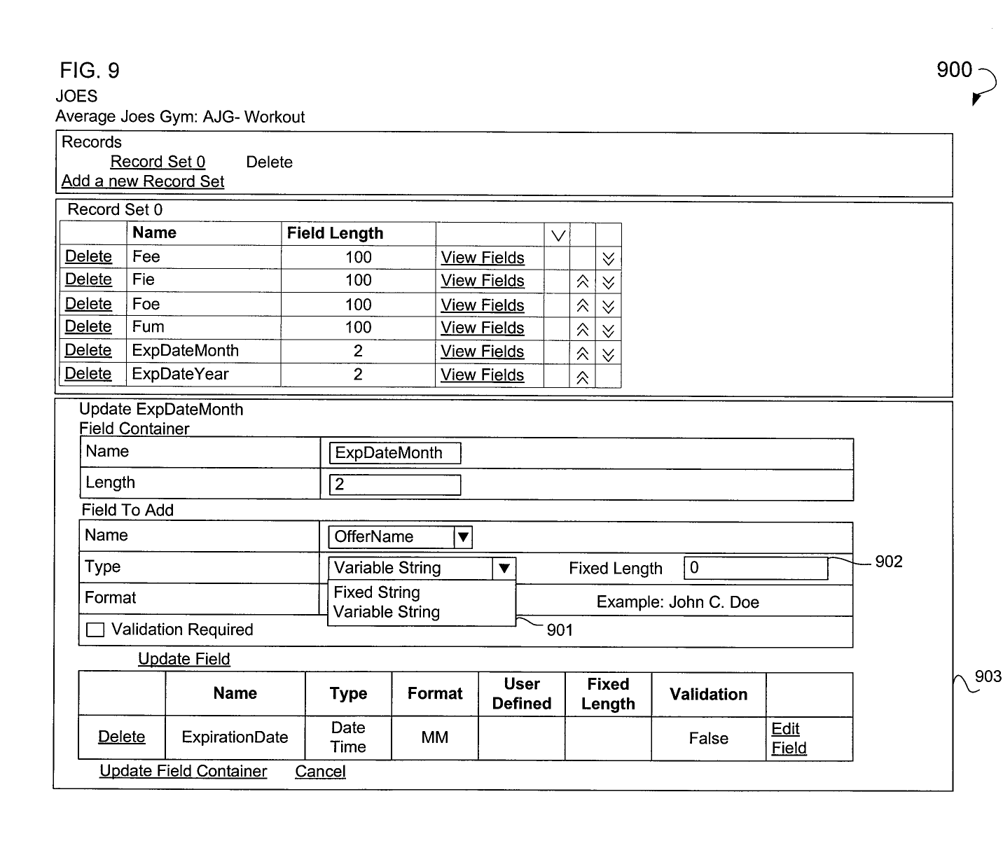

FIG. 9 is a diagram of an example data type interface 900 as might be displayed as a part of the Fulfillment Tool GUI 207. Shown is a data type interface 900 containing or displaying various data types which may be used to add fields to an existing record definition container. This data type interface 900 may be used in conjunction with the field 704. Shown is a drop-down menu 901 that allows one to set a data type for a particular field to be added to a record definition container. Here, for example, the data types are shown through a drop-down menu 901 including a fixed string data type, or a variable string data type. In some example embodiments, the particular data type as displayed in the drop-down menu 901 may be contingent upon the particular type of record definition container that has been selected. Also shown is a textbox 902 that is utilized to determine the length where a fix string data type is selected. This fixed string length may be padded with other predetermined character types such as, for example, a space character type. Further, in some example embodiments, the data types displayed within the drop-down menu 901 may be contingent upon the data type of a selected source field as determined by the drop-down menu 802. For example, if one selects the source field to be of a type that typically requires the use of numbers as opposed to characters than, for example, one will be able to only select a type that relates to numbers such as an integer doubles, or floats. If one selects a data type that relates to characters, then they will be provided the option of selecting some type of string data type as denoted in the drop-down menu 901.

In some example embodiments, the data type interface 900 is generated using technology including AJAX, DHTML, Java Script, Java Applets, C#, VB Script, HTML, XML, or some other suitable technology used to generate a GUI and supporting logic. In some example embodiment, these technologies may be used as a stand alone application, or in conjunction with another application such as a web browser. In example embodiment, using one or more of the above technologies a plurality of frames are generated. For example, a frame 903 is generated that contains the drop-down menu 901, and textbox 902.

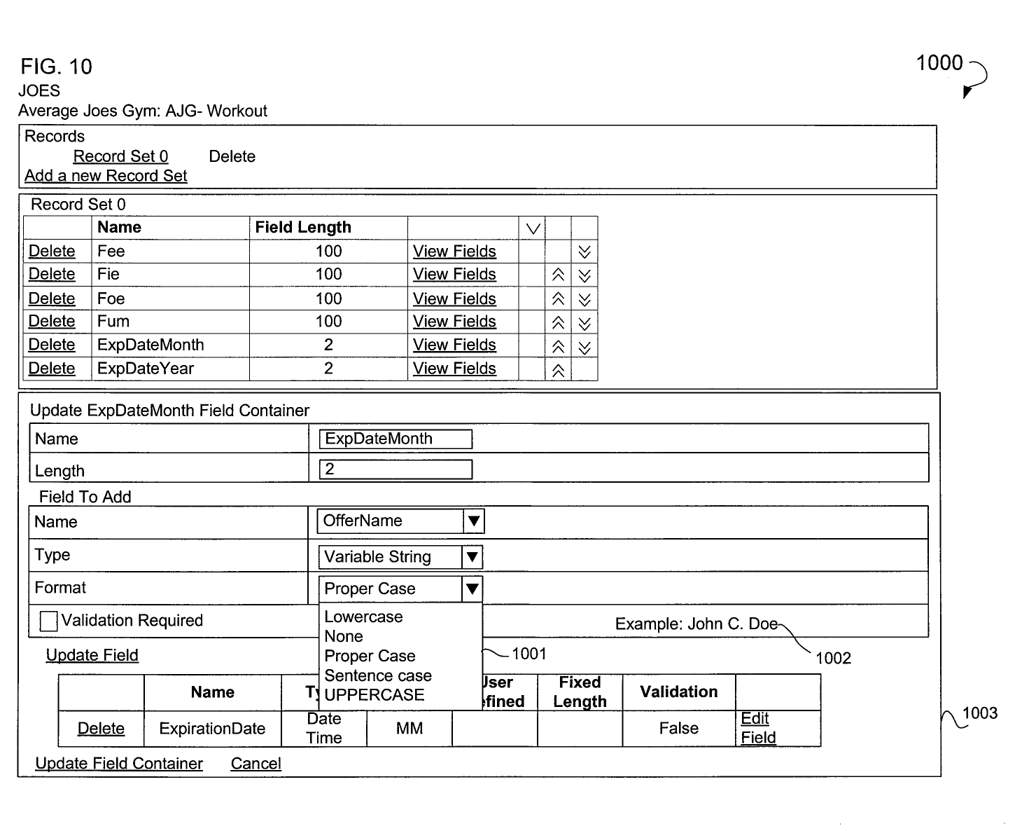

FIG. 10 is a diagram of an example format interface 1000 that may be displayed as part of the Fulfillment Tool GUI 207. Shown are a number of text fields and drop-down widgets associated with the text fields. In some example embodiments, the drop-down menu 1001 may be utilized to display the particular formatting to be applied based upon the particular selected data type. Further, an example field 1002 may be shown that may display an example of the data, contained in the field to be added. The format of that data is dictated by the format selected from the dropdown 1001.

In some example embodiments, format interface 1000 is generated using technology including AJAX, DHTML, Java Script, Java Applets, C#, VB Script, HTML, XML, or some other suitable technology used to generate a GUI and supporting logic. In some example embodiment, these technologies may be used as a stand alone application, or in conjunction with another application such as a web browser. In example embodiment, using one or more of the above technologies a plurality of frames are generated. For example, a frame 1003 is generated that contains the drop-down menu 1001 and field 1002.

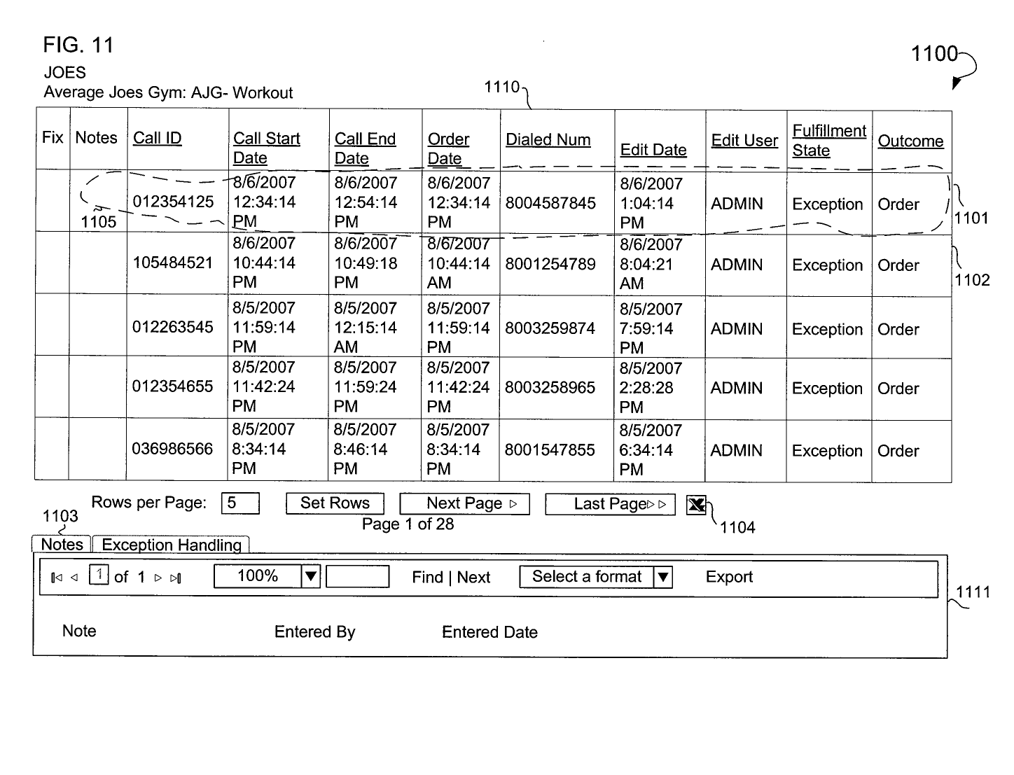

FIG. 11 is a diagram of an example exception handling interface 1100 that may be displayed as a part of the Fulfillment Tool GUI 207. Illustrated is an exception handling interface 1100 that contains a number of fields describing exceptions that have occurred during the course of the network appliance 108 receiving orders. These orders may include, for example, the previously referenced order 105. In some example embodiments these exceptions may relate to incomplete orders. Incomplete orders may lack such information as a complete payment type information (e.g., credit card information), shipping information, sender information, or other information necessary for the completion of a transaction. For example, illustrated is a field 1101 that contains an order during which an exception has occurred. This field 1101 may contain various columns that include, for example, a call ID denoting the ID of the call based upon what order was tendered to the network appliance 108, a call start date, a call end date, an order date, a number dialed that denotes the number that was dialed to place the order such as order 105. In some example embodiments, an edit date is shown denoting a date upon which a user 201 edited a particular order 105. The person who edits the order 105 may be a system administrator or a user 201. In some example embodiments, a fulfillment state is whether or not the order such as order 105 is actually fulfilled or not. An outcome is, for example, whether the order 105 did occur, whether the order was a prank, or whether the order was in error. The field 1102 is also shown containing an additional example of an order and an exception associated with that order. In some example embodiments, a highlight 1005 may be implemented so as to highlight a particular exception of the list of exceptions. In some example embodiments, this list of exceptions describes a list of order that are incomplete due to incomplete information that was not provided during the order process. The order process may include the actual providing of the order 105 to the network appliance 108. This highlighting may be performed, in some example embodiments, through using a mouse to place the focus onto the exception. The highlight 1005 may appear on the screen as some color, shading, or other suitable display effect to denote that the exception has received the focus. A focus may be an operation executed by an Input/Output (I/O) to distinguish one object or widget appearing on a display from another object or widget appearing on a display.

In some example embodiments a note tab 1103 is shown wherein, for example, a user 201 may provide notes with regard to a particular order with which an exception has occurred. These notes may be text-based and may provide some type of detailed information regarding the order 105 or any changes or modifications made to the order 105 by the user 201. Also shown is a screen widget 1104 wherein, for example, by executing the screen widget 1104, the various exceptions displayed as a part of the exception handling interface 1100 may be formatted according to some type of predefined file format such as, for example, Microsoft's XCEL™ file format, Sun's CALC™ file format, or some other suitable file format.

In some example embodiments, example exception handling interface 1100 is generated using technology including AJAX, DHTML, Java Script, Java Applets, C#, VB Script, HTML, XML, or some other suitable technology used to generate a GUI and supporting logic. In some example embodiment, these technologies may be used as a stand alone application, or in conjunction with another application such as a web browser. In example embodiment, using one or more of the above technologies a plurality of frames are generated. For example, a frame 1110 is generated that contains the field 1101 and 1102. Further, a frame 1111 is also generated that contains the note tab 1103.

In some example embodiments, an order as appearing within, for example, a field 1101 or 1102 may be selected by the user 201 utilizing some type of input/output device such as a mouse and associated screen pointer. Once this order is selected, then an exception handling field and associated tab 1201, or a note tab 1103 may be selected and information updated with regard to that particular selected order as displayed in, for example, the field 1101 or 1102.

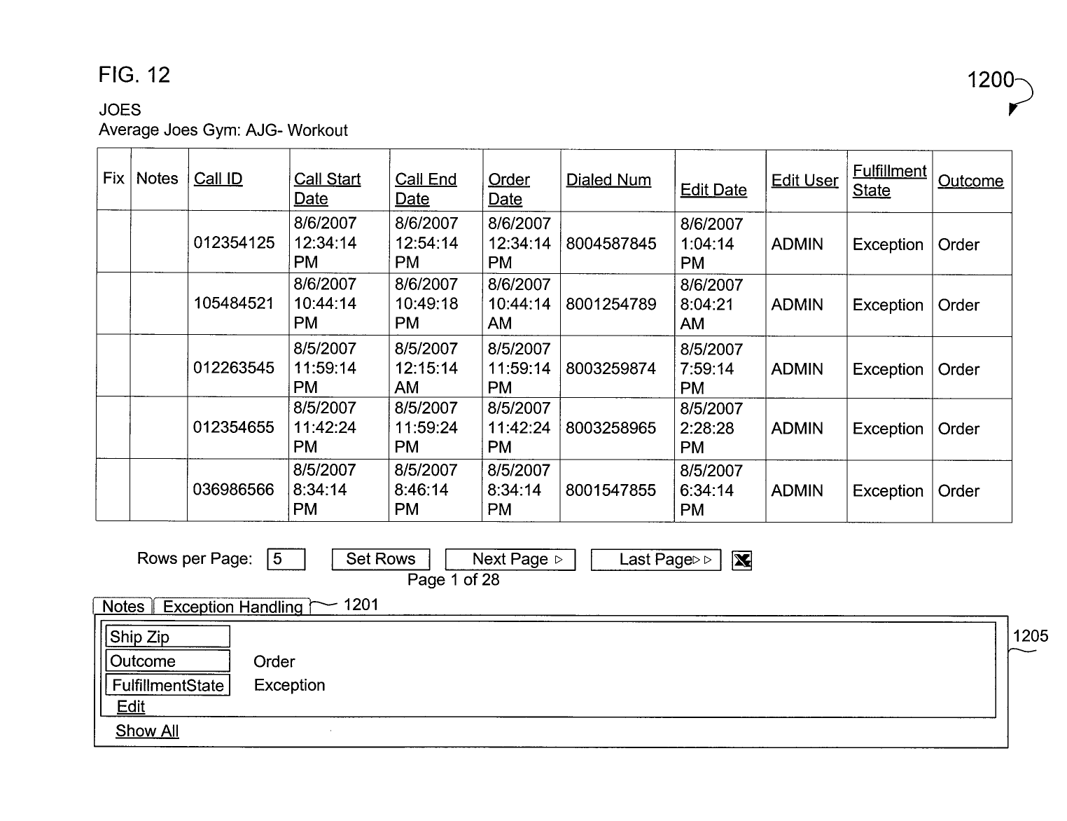

FIG. 12 is a diagram of an example exception handling interface 1200 wherein the user 201 may be able to review the specific exception that exists for a particular order. Shown is an exception handling field and associated tab 1201 that may contain, for example, information relating to a shipping zip code to which the product relating to the orders is to be shipped. Further, information relating to the outcome of a particular order or a fulfillment state of a particular order may be displayed. This field and associated tab 1201, and the data contained therein, may be edited by, for example, the user 201. In some example embodiments, data may be displayed in the field and associated tab 1201, and associated tab that has passed validation and has been corrected. For example, if the user 201 seeks to correct the data relating to a particular order or to denote, for example, whether an exception has occurred and has been fixed, the results of these corrections may be displayed in the field and associated tab 1201.

In some example embodiments, example exception handling interface 1200 is generated using technology including AJAX, DHTML, Java Script, Java Applets, C#, VB Script, HTML, XML, or some other suitable technology used to generate a GUI and supporting logic. In some example embodiment, these technologies may be used as a stand alone application, or in conjunction with another application such as a web browser. In example embodiment, using one or more of the above technologies a plurality of frames are generated. For example, a frame 1205 is generated that contains the field and associated tab 1201.

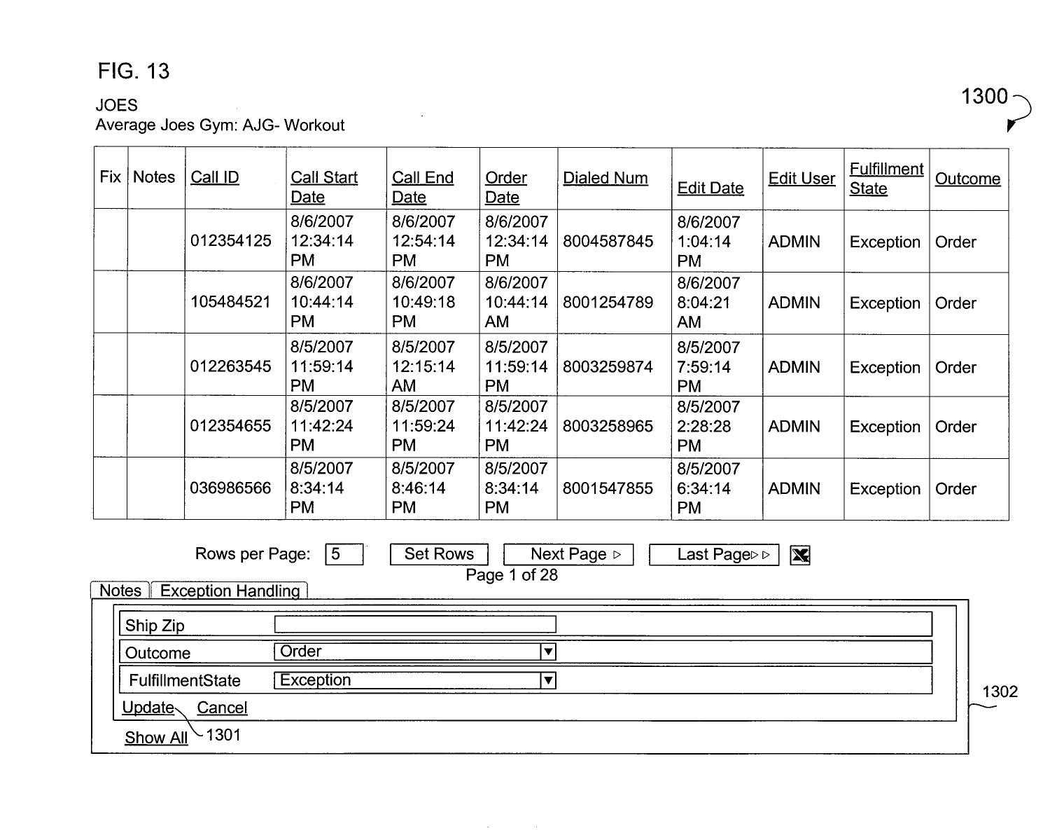

FIG. 13 is a diagram of an example exception handling interface 1300 showing the use of an update trigger. Shown is an exception handling interface 1300 and a screen widget or object 1301 that allows for the user 201 to update information with regard to an exception. Information that may be updated may include, for example, a shipping zip code to which an order is to be shipped, an outcome widget denoting what is the outcome of the order, and a fulfillment state widget that may be used to denote the state of the order. In some example embodiments, the state of the order may be whether the order has been fulfilled, or whether there been an exception.

In some example embodiments, an example exception handling interface 1300 is generated using technology including AJAX, DHTML, Java Script, Java Applets, C#, VB Script, HTML, XML, or some other suitable technology used to generate a GUI and supporting logic. In some example embodiment, these technologies may be used as a stand alone application, or in conjunction with another application such as a web browser. In example embodiment, using one or more of the above technologies a plurality of frames are generated. For example, a frame 1301 is generated that contains the screen widget or object 1301.

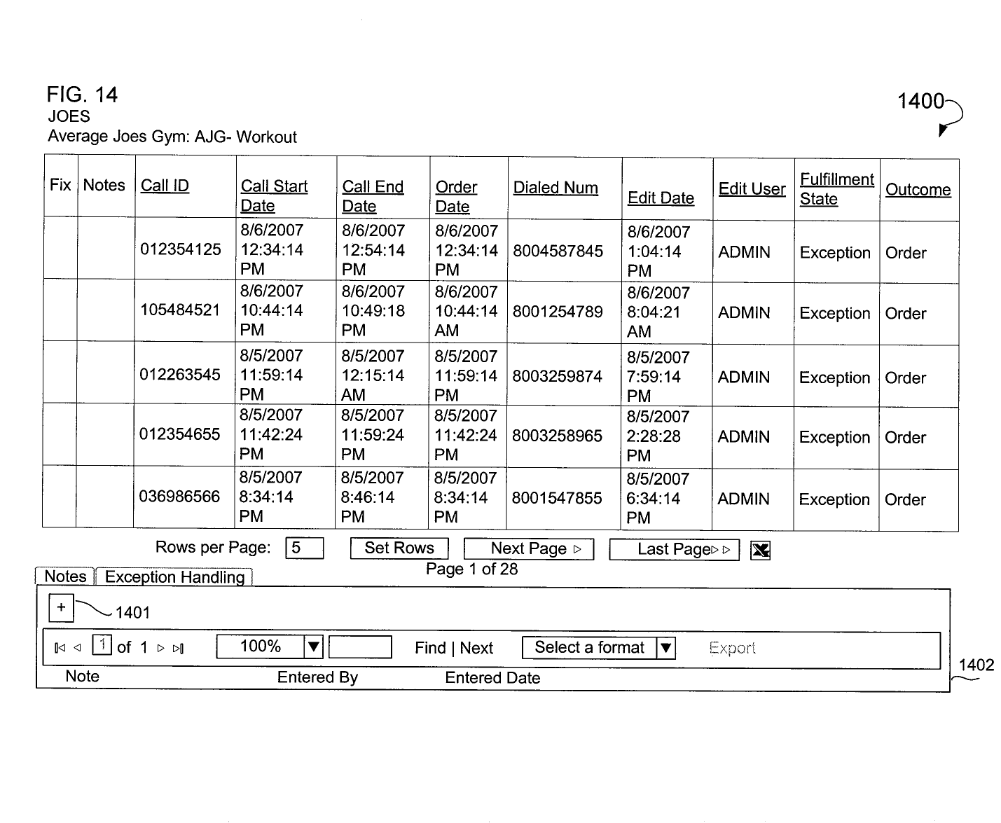

FIG. 14 is a diagram of an example notes expansion interface 1400 to display the ability to add an additional note relating to a particular selected order. Shown is a screen object or widget 1401 that allows the user 201 to add additional notes to a particular selected order. In some example embodiments, as previously described, the order may be selected using some type of I/O device such as a mouse and associated screen pointer. Once selected, additional notes may be added using the I/O device and associated screen pointer.

In some example embodiments, example notes expansion interface 1400 is generated using technology including AJAX, DHTML, Java Script, Java Applets, C#, VB Script, HTML, XML, or some other suitable technology used to generate a GUI and supporting logic. In some example embodiment, these technologies may be used as a stand alone application, or in conjunction with another application such as a web browser. In example embodiment, using one or more of the above technologies a plurality of frames are generated. For example, a frame 1402 may be generated that contains the screen object or widget 1401.

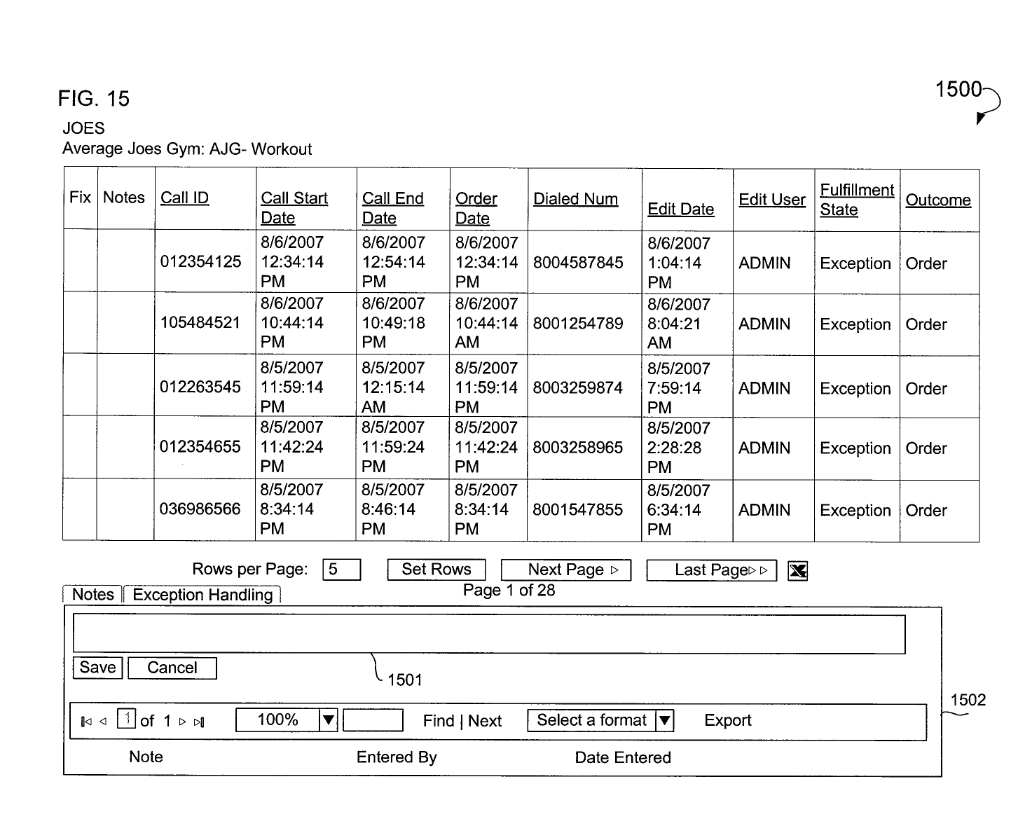

FIG. 15 is a diagram of an example notes interface 1500 as it may appear in, for example, the fulfillment tool GUI 207. Shown is a textbox 1501 that allows the user 201 to enter additional notes with regard to a particular selected order. These notes may be added with a keyboard or other suitable I/O device. This selected order may be, for example, the order as appearing in fields 1101 or 1102. The notes may be provided by the user 201 as inputted into the textbox 1501. As previously described, in exception notes expansion interface 1400 a plurality of notes may be entered with regard to a particular order.

In some example embodiments, example notes interface 1500 is generated using technology including AJAX, DHTML, Java Script, Java Applets, C#, VB Script, HTML, XML, or some other suitable technology used to generate a GUI and supporting logic. In some example embodiment, these technologies may be used as a stand alone application, or in conjunction with another application such as a web browser. In example embodiment, using one or more of the above technologies a plurality of frames are generated. For example, a frame 1502 may be generated that contains the textbox 1501.

In some example embodiments, a computer system having a GUI including a display and a selection device, a method of providing and selecting from a menu on the display, is shown. This computer system may, for example, be the one or more devices 202. The method that may be executed on these one or more devices 202 may include various operations that may include retrieving a product list associated with a client. This product list may part of a product list interface (see e.g., FIG. 3). Further, an operation may be executed that displays the product list associated with the client. Some example embodiments may include, the client being an advertiser, a seller, a buyer, or some other suitable party that may transact in good and services. Further, in some example embodiments, the GUI may include operations to execute the display and the selection device, further comprising retrieving a product overview related to a product associated with a client, and displaying the product overview with an event history for the product associated with the client. In some example embodiments, this product overview is referenced as a product overview interface (see e.g., FIG. 4). Moreover, in some example embodiments, operations may be executed that retrieve a record definition associated with the product defining a data format relating to records associated with the product, and displaying the record definition. In some example embodiments, a record definition may be displayed as part of a number of interfaces (see e.g., FIGS. 5-8). Additionally, in some example embodiments, operations may be executed that retrieve a list of exceptions associated with an order relating to the product associated with a client, and which display the list of exceptions. Some example embodiments may include, displaying a list of exceptions as part of an interface (see e.g., FIGS. 11-15). In some example cases, an operation may be executed to execute the display and the selection device of claim 22, further comprising highlighting an exception that appears in the list of exceptions (see e.g., FIG. 11). In some example embodiments, the operations referenced above may be implemented in hardware, software, or firmware.

### Example Fulfillment Logic

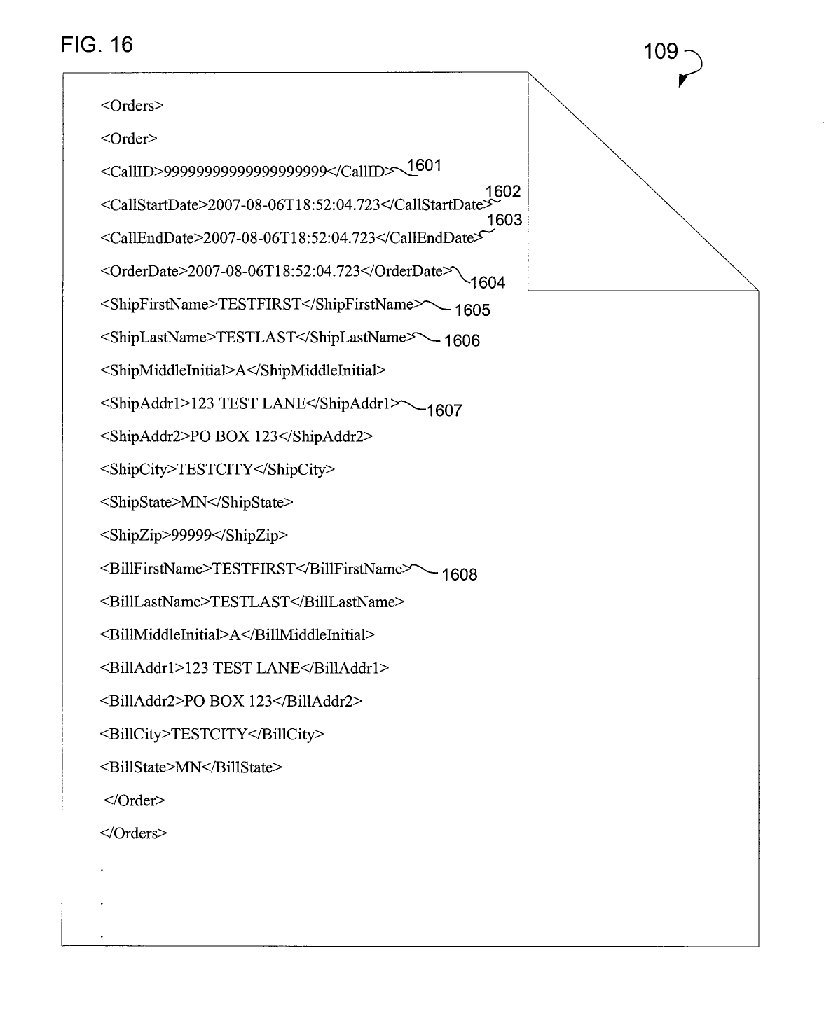

FIG. 16 is a diagram of example transaction data 109. In some example embodiments this transaction data 109 may be written using XML, CSV file, or some other suitable file format. Shown is transaction data 109 formatted in XML. Illustrated is a field 1601 containing a call ID value where this call ID value is a unique identifier used to denote a particular call and a specific order such as order 105. Next, a field 1602 is shown that denotes a call start date, that is, the date upon which a call was initially made, and the order 105 generated. Further, a field 1603 is shown denoting the end date of a particular call and associated order such as order 105. In some example embodiments, the fields 1602 and 1603 denote a calendar date and associated time. Also shown is a field 1604 denoting an order date for a order 105. A field 1605 is also illustrated denoting the first name of the party to whom order 105 is to be shipped. This party may be, for example, the previously referenced customer 106. A shipping last name field 1606 is shown. This field may contain data relating to the last name of the party to whom an order 105 is to be shipped such as customer 106. Also shown is a field 1607 containing a shipping address information for a particular party to whom an order, such as order 105, and corresponding products, are to be shipped. The shipping address information contained within field 1607 may relate to a shipping address for the customer 106. Further shown is a field 1608 containing billing information for a particular customer such as customer 106. This billing information may relate to the particular billing address for some type of method of payment including, for example, credit card, debit card, or some other type of payment method.

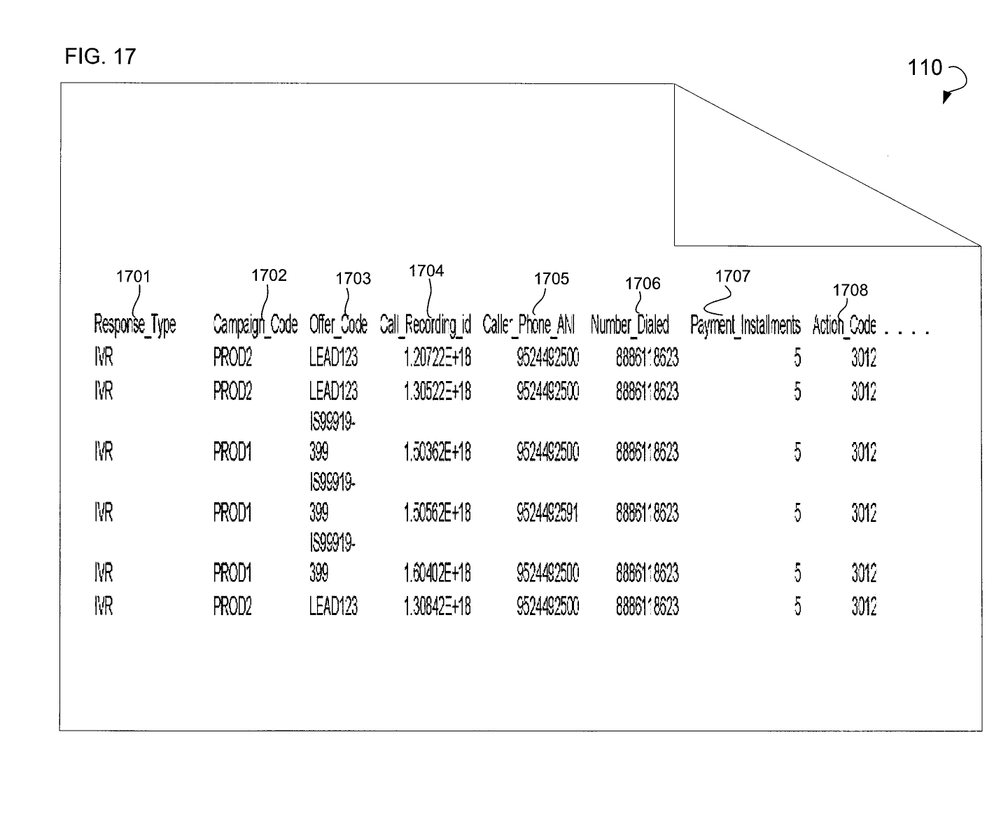

FIG. 17 is diagram illustrating an example fulfillment file 110. In some example embodiments, the fulfillment file 110 may be generated by a database server 112 where this fulfillment file 110 is generated as the result of the application of a record definition XML 208 to transaction data 109. Shown are a number of fields contained within this fulfillment file 110. These fields, and the formatting used to generate these fields and to edit, modify, or format the data contained in these fields, may be dictated by, for example, the previously referenced record definition containers. These record definition containers are, in turn, generated through the actions of the user 201 and various formats as dictated by, for example, the advertiser 209. Shown is a column 1701 titled “Response Type.” In some example embodiments, such a response type may be an IVR response type. Also shown is a column 1702 containing a campaign code relating to a particular advertising campaign associated with the particular order. Next, a column 1703 is shown denoting a particular offer code based upon which an order such as order 105 was generated. In some example embodiments, the offer code may correspond to a particular advertisement generated by the advertiser 209. The column 1704 is also shown that denotes a call recording ID, which is the identification of particular network appliance 108 that records or otherwise takes the order 105 from the customer 106. Also shown is a column 1705 denoting a caller phone identifier.

In some example embodiments, a unique identifier may be associated with a particular caller's phone such that if customer 106 utilizes a traditional telephone 104, the traditional telephone 104 may be known by a unique identifier associated with traditional telephone 104. Also shown is a column 1706 wherein column 1706 shows the number that the customer 106 dialed during the course of facilitating the order 105 to the network appliance 108. A column 1707 is illustrated containing the number of installments that the customer 106 may make to actually purchase an item as reflected in the order 105. In some example embodiments, the customer 106 may purchase a good via the order 105 on some type of installment purchase basis. Here, for example, column 1707 denotes that payments may be made in five installments. Also shown is a column 1708 containing various action codes associated with a purchase or order. These action codes may relate to various activities that may be undertaken by, for example, the advertiser 209 or the user 201.

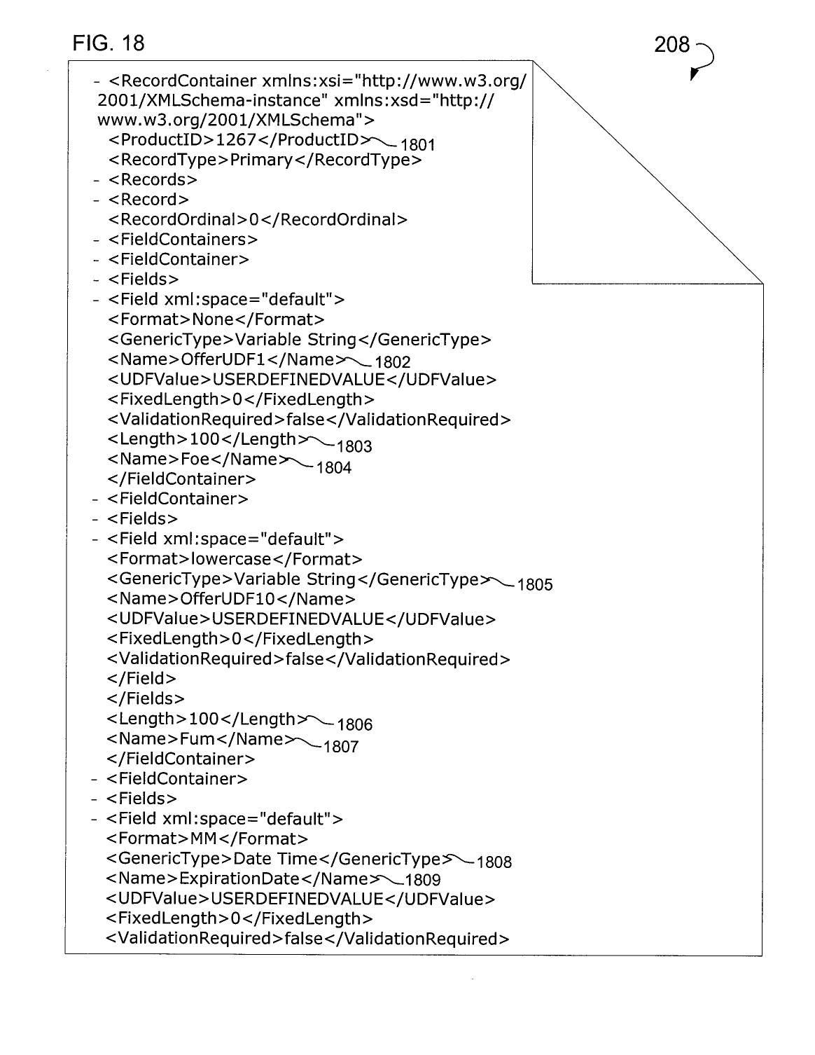

FIG. 18 is a diagram of an example record definition XML 208. Contained within this record definition XML 208 are a number of fields. In some example embodiments, multiple containers are represented via multiple fields. For example, a field 1801 is shown wherein this field 1801 contains a unique product identifier used to identify a product associated with an order or a product associated with a particular advertisement. Additionally, a field 1802 is shown that contains the name of a particular field as a part of a record definition container. Further, a field 1803 is shown wherein the length of the field is length in terms of characters. A field 1804 is shown that contains the name of the field that is a part of the record definition container. Further, a field 1805 is shown that contains a data type associated with the field that is a part of the record definition container. Additionally, a further field 1806 is shown to denote the length of a field that is additionally associated with the record definition container. Similarly, a field 1807 is shown that contains the name of the additional field that is associated with the record definition container. Further, a field 1808 is shown that contains the data type associated with the additional field that is a part of the record definition container. Moreover, a field 1809 is shown that denotes the name of the field to be added or the field that is a part of a particular record definition container. As shown in the record definition XML 208, a particular record definition container may contain a plurality of fields wherein each one of these fields may have a name, value, and a length value corresponding to the length or size of characters used to fill this field. Other information including, for example, a data type associated with the data to be taken into the field and a formatting value associated with this data type may also be associated with this record definition container.

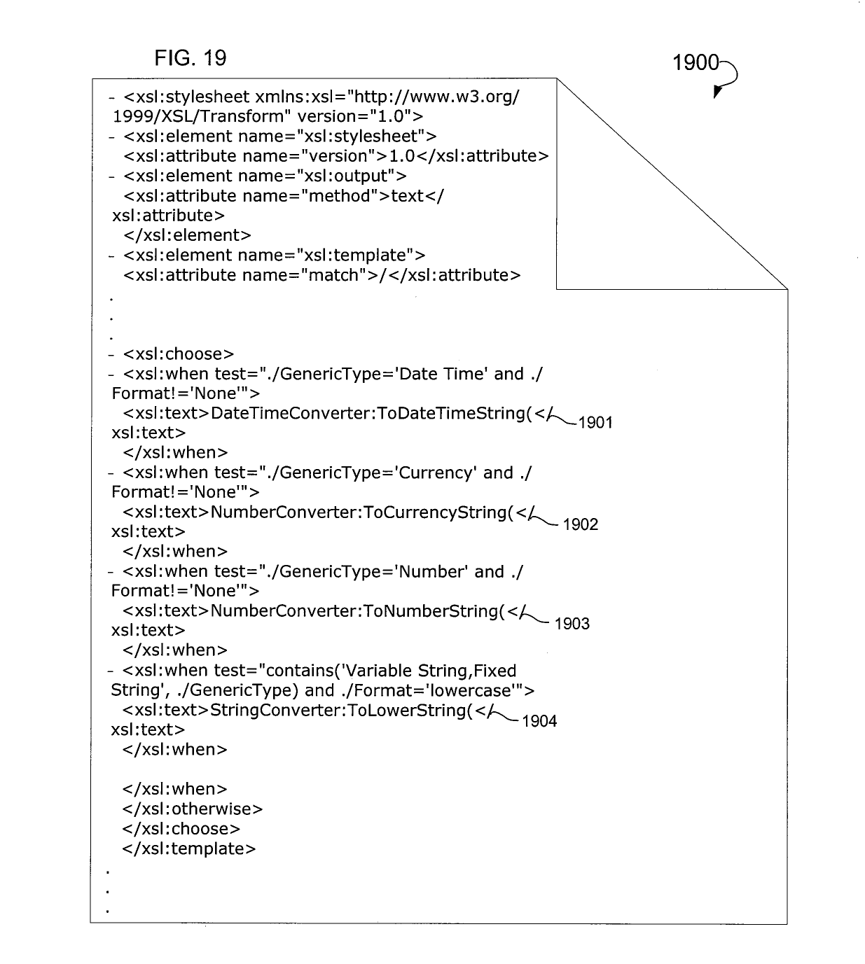

FIG. 19 is a diagram of an example internal XSL 1900. Shown is an internal XSL 1900 that may be generated by, for example, the user 201. This internal XSL 1900 may be used as a schema to translate or transform one type of XML into another type of XML, wherein the format of the first XML and the second XML differ. Illustrated is a field 1901 that contains data relating to the manner in which date/time information in a numerical format may be translated into date/time information in a string format. Further, a field 1902 is shown that describes how a number may be converted to a number as used in the form of currency data type. Further, a field 1903 is shown that describes how a number may be converted from a number data type (e.g., integer, float, or double) to a number in the form of a string. Additionally, a field 1904 is shown that describes how a string may be converted to a lower string. In some example embodiments, the various types of conversions as reflected in fields 1901 through 1904 are illustrative such that other types of conversions may take place. For example, an integer may be converted to string, a string may be converted to an integer, or some other suitable types of conversions may be dictated by the internal XSL 1900.

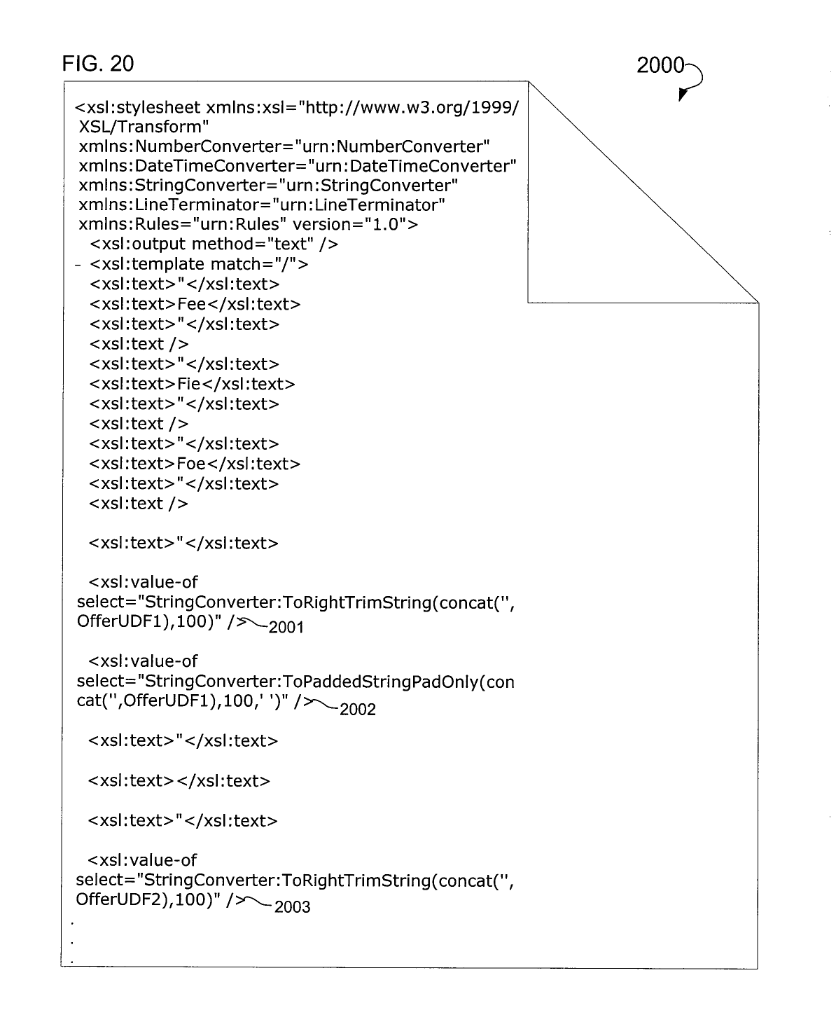

FIG. 20 is a diagram of an example record definition XSL 2000. Shown is a record definition XSL 2000 that dictates how a particular record definition XML 208 may be formatted. This record definition XSL 2000 may be generated by, for example, the user 201 such that formatting requirements and characteristics as dictated by an advertiser 209 may be applied to the transaction data 109 such that a fulfillment file 110 may be generated that reflects the formatting requirements of the advertiser 209. Shown is a field 2001 containing a conversion value to convert a string to a particular type of string, as dictated by a field in a record definition container. Also shown is a field 2002 that illustrates a further example of a manner in which a string is contained within the transaction data 109 may be formatted. This field 2002 may contain formatting requirements as a part of a field that is contained in a record definition file. Further, a field 2003 also provides instructions as to how transaction data 109 may be formatted.

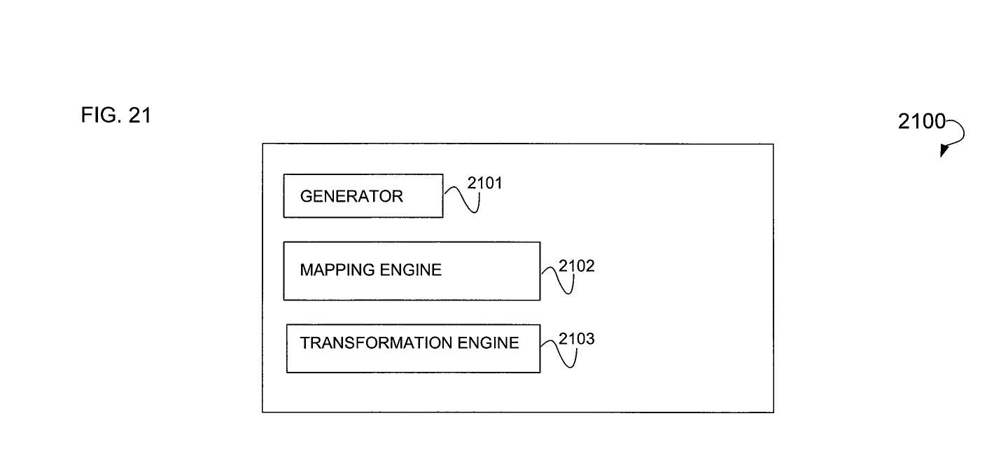

FIG. 21 is a block diagram of an example computer system 2100. In some example embodiments, this computer system 2100 may be the database server 112. Some example embodiments may include the implementation of the various blocks shown herein as implemented in hardware, firmware, or software. Illustrated is a generator 2101 to generate a translation rule file describing a first rule to be used to translate a record definition file. A mapping engine 2102 is shown to map the record definition file, using the first rule, to generate a record definition rule file describing a second rule used to translate transaction data. Further, a transformation engine 2103 is shown that transforms the transaction data 109, using the second rule, to generate the fulfillment file 110.

In some example embodiments, the first rule is written in XML and describes a data type. Further, in some example embodiments, the data type includes a description of another mapping from a first data type to a second data type. Additionally, in some example cases, the record definition file is written in XML and describes a file format associated with a client. In some example cases, the file format associated with the client relates to a format used in describing at least one of a transaction in commerce, client request data, and consumer information data. In some example embodiments, the fulfillment file 110 is formatted according to the file format associated with the client. Additionally, in some example embodiments, the second rule is written in XML and describes a data type conversion. Some example embodiments may include the data type conversion that includes at least one of concatenating at least two data fields, converting from one data type to a second data type, converting using a user defined field. In some example embodiments, the fulfillment file 110 is formatted with a format including at least one of an XML based format, a character delimited flat file format, and a fixed length file.

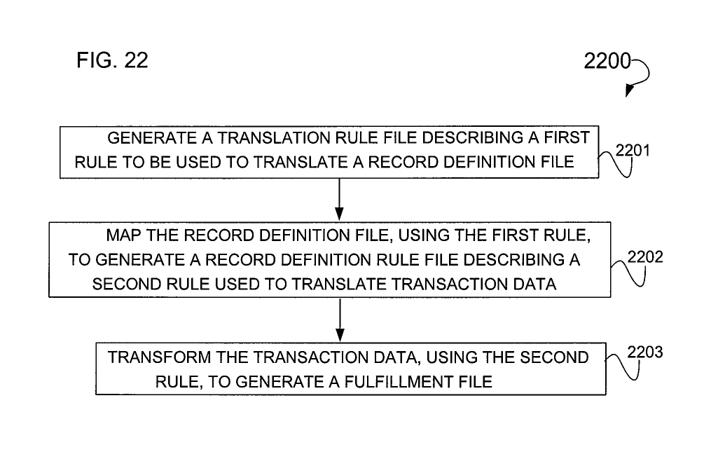

FIG. 22 is a flow chart illustrating an example method 2200 to generate a fulfillment file 110. Shown is an operation 2201 that when executed generates a translation rule file describing a first rule to be used to translate a record definition file. An operation 2202 is also shown that, when executed, maps the record definition file, using the first rule, to generate a record definition rule file describing a second rule used to translate transaction data. An operation 2203 is executed, in some example embodiments, to transform the transaction data, using the second rule, to generate a fulfillment file. In some example embodiments, the first rule is written in an XML and describes a data type. Some example embodiments may include the data type as including a description of another mapping from a first data type to a second data type. Further, in some example embodiments, the record definition file is written in XML, and describes a file format associated with a client. Additionally, in some example embodiments, the file format associated with the client relates to a format used in describing at least one of a transaction in commerce, client request data, and consumer information data. Moreover, in some example embodiments, the fulfillment file 110 is formatted according to the file format associated with the client. Some example embodiments may include, the second rule is written in XML and describes a data type conversion. Further, the data type conversion, in some example embodiments, includes at least one of concatenating at least two data fields, converting from one data type to a second data type, converting using a user defined field. The fulfillment file 110 is formatted, in some example embodiments, with a format including at least one of an XML based format, a character delimited flat file format, and a fixed length file.

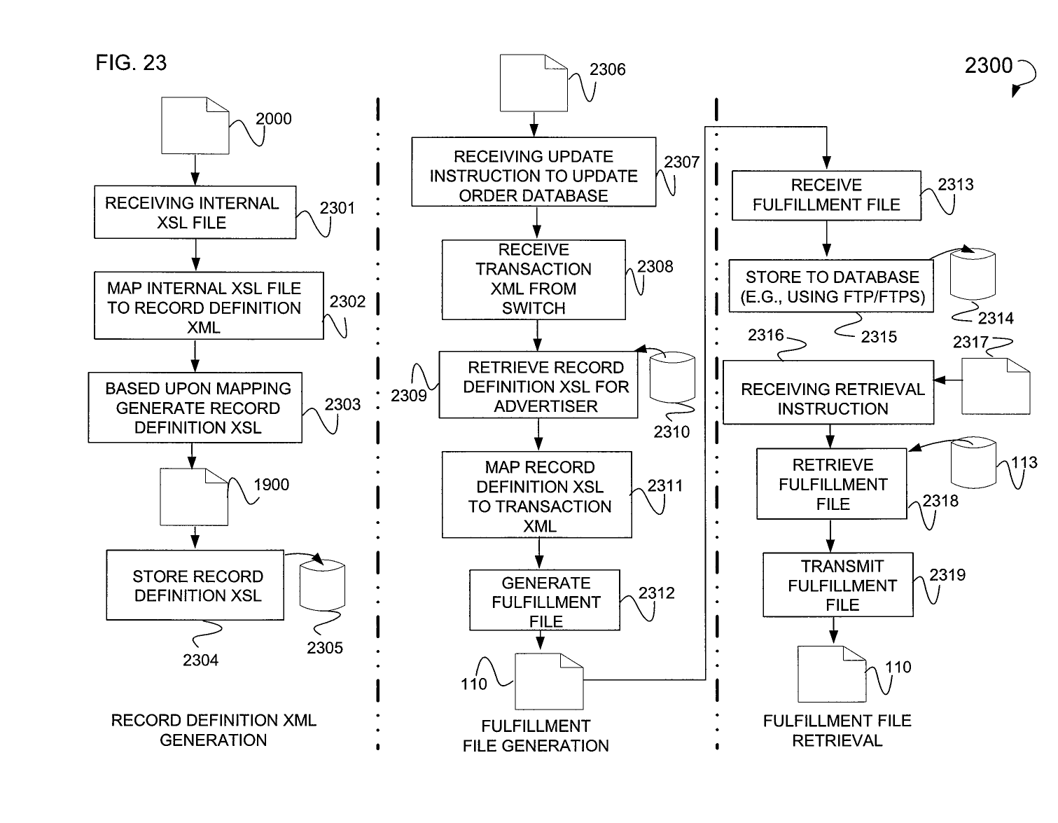

FIG. 23 is a flowchart illustrating an example method 2300 used to generate a fulfillment file 110 and to retrieve this fulfillment file 110. Shown is a first stream titled “Record Definition XML Generation” containing operations 2301 through 2304, and an accompanying database 2305. Also shown is a second stream titled “Fulfillment File Generation” containing operations 2307 through 2308, 2311 though 2312, and an accompanying database 2310. Additionally shown, is a third stream titled “Fulfillment File Retrieval” containing operations 2313, 2315, 2316, 2318, and 2319, and an accompanying database 2314.

In some example embodiments, illustrated is a Record Definition XML Generation stream containing an operation 2301. In example cases where operation 2301 is executed, an internal XSL 1900 file may be retrieved. An operation 2302 may also be executed that maps the internal XSL 1900 file to a record definition XML, where this record definition XML may be, for example, a record definition XML 208 generated by user 201 utilizing the Fulfillment Tool GUI 207. An operation 2303 may also be executed that generates a record definition XSL file 1900. An operation 2304 may be executed that then stores the record definition XSL file 1900 into a database or database 2305.

In some example embodiments, an operation 2307 is executed that, when executed, receives update instructions to update an order database 113. These update instructions in the form of, for example, update instructions 2306 may be received and then used to update the order database 113. An operation 2308 may be executed that receives transaction data 109 in the form of, for example, transaction XML from a network appliance 108. An operation 2309 may be executed that retrieves record definition XSL 2000 for a particular advertiser from a database 2310. An operation 2311 may be executed that maps a record definition XSL 2000 to a transaction XML, where this transaction XML may be, for example, the transaction data 109. An operation 2312 may be executed that generates a fulfillment file 110.

In some example embodiments, an operation 2313 may be executed that receives the fulfillment file 110. An operation 2315 may be executed as stores the fulfillment file 110 to a database such as database 2314 using, for example, FTP, or File Transfer Protocol Secure (FTPS). In some example embodiments, a retrieval instruction 2317 may be received through the execution of an operation 2316. An operation 2318 may then be executed that retrieves the fulfillment file 110 from the order database 113. An operation 2319 may be executed that transmits this fulfillment file 110 to, for example, a host 114. In some example embodiments, the various operations illustrated herein (e.g., operations 2301, 2302, 2303, etc.) may reside as a part of, for example, the database server 112. Some example embodiments may include, these various operations residing as a part of the previously referenced one or more devices 202.

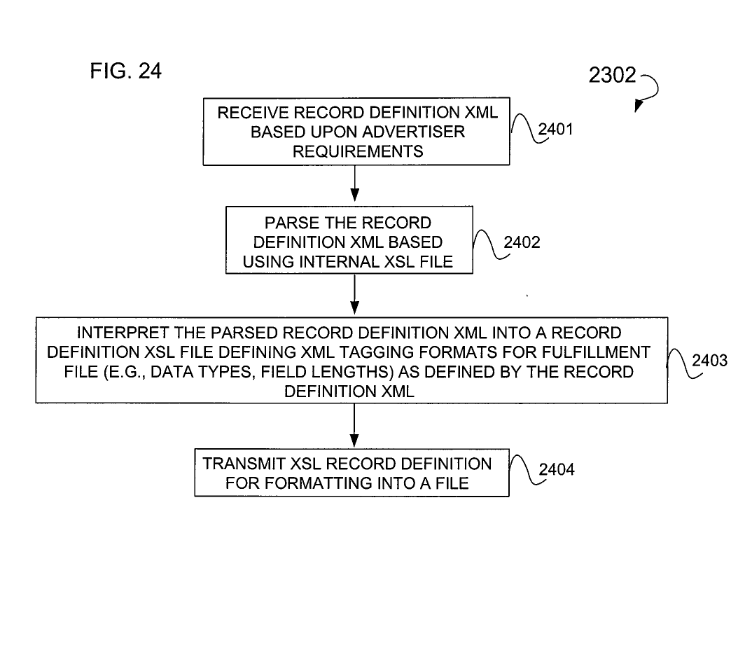

FIG. 24 is a flowchart illustrating example a method to execute an operation 2302. Shown is operation 2401 that receives record definition XML 208. This record definition XML 208 may be generated by the user 201, whereas the advertiser requirements may be certain types of requirements provided to the user 201 by the advertiser 209. An operation 2402 may be executed that parses the record definition XML based upon some type of internal XSL file such as, for example, the internal XSL file 1900. An operation 2403 may be executed that interprets the parse record definition XML 208 into a record definition XSL file 2000 for defining the XML tagging formats for a fulfillment file 110 as defined by the record definition XML 208. These tagging formats may include data types, field lengths, and other types of suitable information associated with the field that is contained within a record definition container. An operation 2404 may be executed that transmits the record definition XSL 2000 file for formatting into a file.

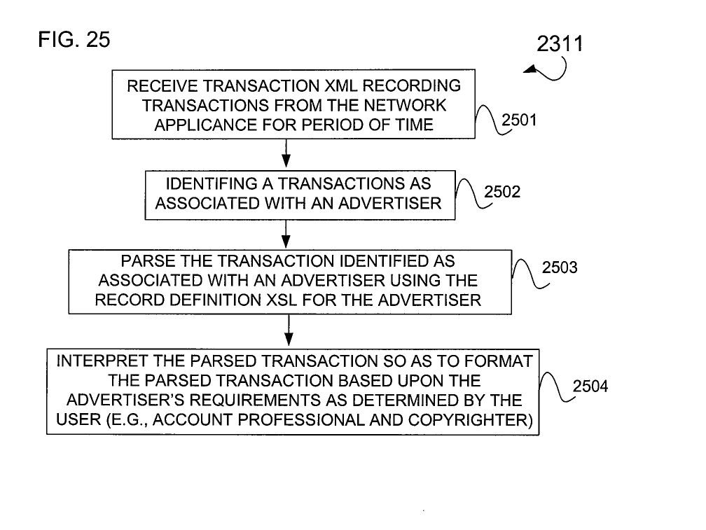

FIG. 25 is a flowchart illustrating an example method 2311 that may include the processing of XML from a network appliance 108. Shown is an operation 2501 that receives transaction XML (e.g., transaction data 109) recording one or more transactions utilizing the network appliance 108 over some predetermined period of time. In some example embodiments, the various transactions include, for example, the various orders such as, for example, order 105, from a variety of customers including, for example, customer 106. An operation 2502 may be executed that identifies a transaction that is being associated with a particular advertiser such as advertiser 209. An operation 2503 may be executed that parses this transaction using the record definition XSL 2000 for a particular advertiser such as advertiser 209. An operation 2504 may be executed that interprets the parts of the transaction so as to format the parts of the transaction based upon the advertiser's requirements as determined by the user. This user may be, for example, the user 201.

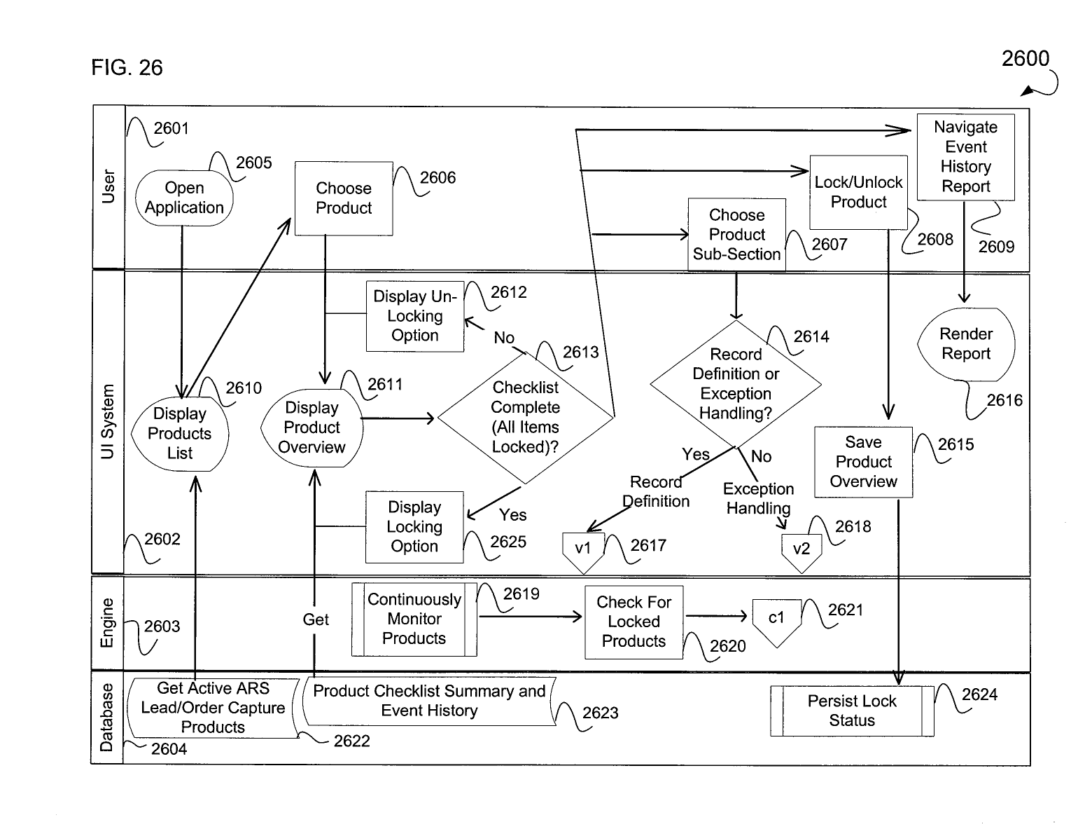

FIG. 26 is a flowchart illustrating an example method 2600 used to display various interfaces such as, for example, those interfaces shown in FIG. 5 through 15. In some example embodiments, the method for translating transaction data into some type of fulfillment file 110 and the interfaces associated with this translation may be understood in terms of a three-tier software architecture. A three-tier software architecture is known in the art and may include, for example, an interface tier, a logic tier, and a database tier. As described herein an engine may be associated with the logic tier.

In some example embodiments, shown is an interface tier referenced herein as a user 2601. Contained within this tier are a number of operations including, for example, an operation 2605 used to open an application. Also shown is a choose product operation 2606. Further, a choose product sub-selection operation 2607 is shown, and an lock/unlock product operation 2608. Further, an operation 2609 is shown that is used to navigate an event history report.

In some example embodiments, a logic tier referenced as a UI system tier 2602 and an engine tier 2603 are shown. Residing as a part of these tiers are a number of operations that include, for example, a display products list operation 2610, a display product overview operation 2611, a display unlocking option operation 2612, decisional operation 2613 used to determine whether a checklist is complete, a decisional operation 2614 used to determine whether or not a record definition or exception handling exists for a particular order such as order 105. An operation 2615 is used to determine whether or not the product or review should be saved that render a report operation 2616. Moreover, an operation 2625 is shown for displaying locking option, a record definition operation 2617 is shown, and an exception handling operation 2618 is also shown. Further, an operation 2619 is shown that is used to continuously monitor products. Additionally, an operation 2620 is shown to check for locked products in an operation 2621. Also, a database tier 2604 is shown wherein a get active order or capture products information is displayed as a part of operation 2622. A product checklist summary and event history is displayed as a part of operation 2623, and further a persistent lock status operation 2624 is shown. Collectively each one of these operations may be referenced by their operation.

In some example embodiments, an operation 2605 is executed that opens an application. Once opened, a product list is displayed as a part of operation 2610 (see e.g., FIG. 3.). In some example embodiments, the user 201 may chose a specific product through executing operation 2606. An operation 2612 may then be executed by the user 201 to display an unlocking option for a product. An operation 2611 may be executed that displays a product overview as shown in, for example, FIG. 4. A decisional operation 2613 may then be executed that determines whether or not the checklist for the displayed product is complete. In example cases where decisional operation 2613 evaluates to no (e.g., “false”) the operation 2612 may be re-executed. In example cases where decisional operation 2613 evaluates to yes (e.g., “true”) an operation 2625 may be executed that displays a locking option for that particular product. In some example embodiments, upon the completion of the execution of decisional operation 2613, an operation 2607 may be executed that allows the user 201 to choose a product sub-selection. In example cases where operation 2607 is executed, a further decisional operation 2614 may be executed that determines whether or not record definition or exception handling for a particular sub-section has been selected.

In example cases where decisional operation 2614 evaluates to yes (e.g., “true”) a record definition operation 2617 may be executed that allows for the future modification of the record definition. In example cases where decisional operation 2614 evaluates to no (e.g., “false”) exception handling may be selected through the execution of the operation 2618 for future use. In some example embodiments, upon the completion of the execution of the decisional operation 2613, the operation 2608 may be executed to allow a user, such as user 201, to lock or unlock a product for modification. Once operation 2608 is executed a further operation 2615 may be executed that saves a product for over review. Further, in some example embodiments, upon the successful execution of operation 2615, a further operation lock status 2624 may be executed that determines a persistent lock status for a particular product. A further result of the successful completion of the execution of decisional operation 2613 may be the execution of the operation 2609. Operation 2609 allows the user 201 to navigate an event history report using some type of external input/output device such as a mouse and an associated mouse pointer that may exist upon a screen. In some example embodiments, an operation 2616 may be executed that renders a report or in some other way displays a report on a screen.

Some example embodiments may include, a formatting engine 2603 may be executed. Residing as a part of this formatting engine 2603 may be, for example, an operation 2619 that continuously monitors a product. During the course of this continuous monitoring of the product, an operation 2620 may be executed that checks for locked products, and where locked products are encountered, a further operation 2621 may be executed. As part of the database tier 2604 an active ARSs may be retrieved. Further, a product checklist, summary, or event history may be retrieved as a part of the execution of operation 2623. Additionally, the persistent lock status operation 2624 previously referenced may exist as a part of this database tier 2604.

In some example embodiments, the operation 2619 is executed so as to continuously monitor products. Further, in some example embodiments, an operation 2620 is executed to ensure that certain products are locked. A monitored product may be a product for which there is an active record definition container. A locked product is a product for which there is a locked definition container. Further, in some example embodiments, the execution of operation 2621 results in the pushing or pulling of the fulfillment file 110, and the sending of this fulfillment file 110 to the host 114.

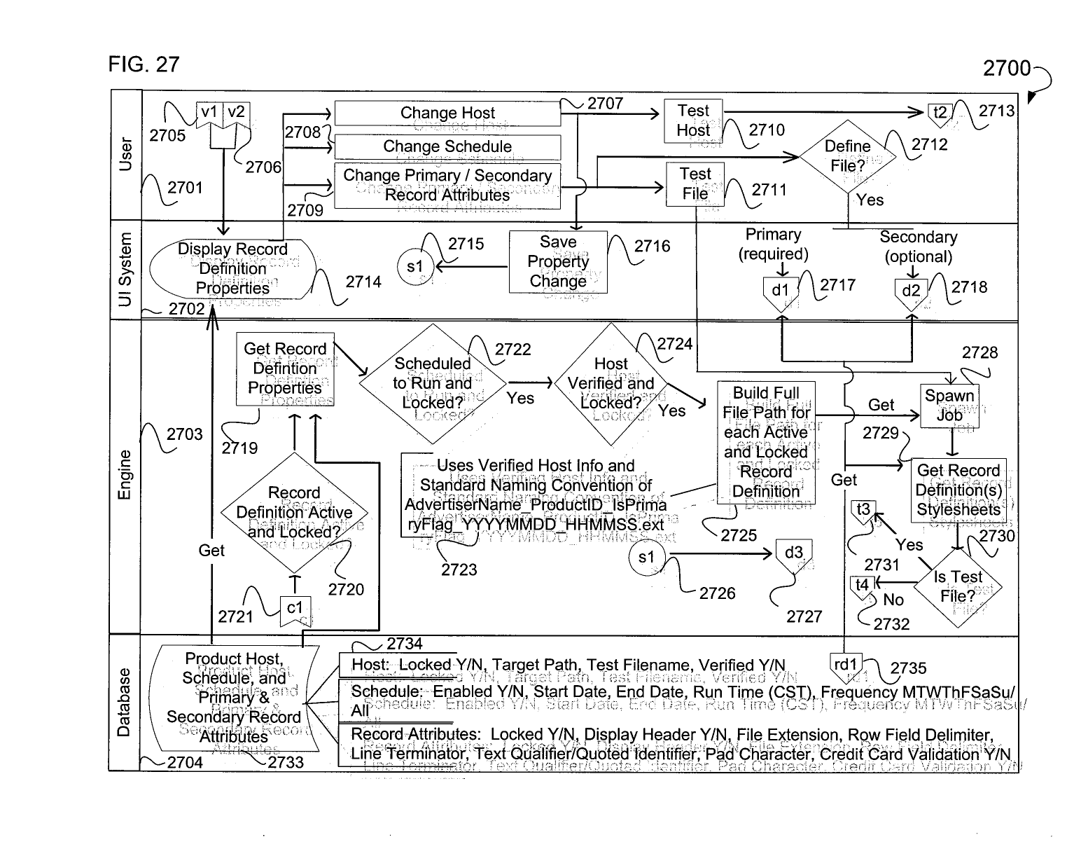

FIG. 27 is a flowchart illustrating example method 2700 that results from the execution of record definition operation 2617 and exception handling operations 2618. In some example embodiments, FIG. 27 is divided into a three-tier software architecture with an interface tier, referenced as a user tier 2701, a logic tier composed of a UI system tier 2702, and an engine tier 2703. Additionally, a database tier 2704 is also shown. Residing in each one of these tiers is a number of operations. For example, part of the user tier 2701 contains, for example, an operation 2705 that corresponds to the previously referenced record definition operation 2617 and an operation 2706 is shown that corresponds to the previously referenced operation 2618. Also contained as a part of this user tier 2701 is an operation 2707 that may be used to change a host, an operation 2708 that may be used to change a schedule, and an operation 2709 that may be used to change primary or secondary record attributes. Further, an operation 2710 is shown that allows the user 201 to test a host. Further, an operation 2711 is shown that allows the user 201 to test a file. Further, a decisional operation 2712 is shown that allows for the user 201 to define a file. Further, an operation 2713 is shown that allows for the execution of a further operation. Residing as a part of the UI system tier or level 2702 is an operation 2714 that allows further display of record definition properties (e.g., fields). Further, an operation 2715 is shown that allows for future operations to be executed. Also, an operation 2716 is shown that, when executed, may save various changes made to a record definition container by the user 201. An operation 2717 may be executed that results in further operations being executed, or an operation 2718 may be executed that also results in further operations being executed at some future time.

In some example embodiments, residing as a part of the engine tier 2703 is an operation 2719 that, when executed, gets record definition properties. Further, a decisional operation 2720 is shown that records record definitions activity, and when it is locked, further decisional operations 2722 and 2724 are also illustrated. Further, residing as a part of the engine tier 2703, is an operation 2725, an operation 2728, a decisional operation 2730, and an operation 2729. Further, shown are various future operations including operation 2726, 2727, 2731 and 2732.

Some example embodiments may include the database tier 2704. This database tier 2704 may include a product host schedule and primary data 2733, and various explanations pertaining to this data including, for example, explanation 2734. Future operations 2735 may also reside as a part of this database tier 2704. In some example embodiments, an operation 2705 and/or 2706 may be executed that result in the display of record definition properties operation 2714. Once these record definition properties are displayed, the user 201 may have any one of a number of choices available to them such that further operations may be executed. For example, the user 201 may choose to execute operation 2707 to change the host or, they may choose to execute operation 2708 to change the schedule or again. Further, they may choose to execute operation 2709 to change primary or secondary record attributes. These various executions of operations 2707 through 2709 may be executed via a screen object or widget that is selected via some type of external input/output device such as, for example, a mouse and associated screen pointer. Cases where operation 2707 is executed, a further test host operation 2710 may be executed that results in the execution of future operations 2713. Cases where operation 2709 is executed an operation 2711 may be executed in the test of a file. Further, in cases where operation 2709 is executed a decisional operation 2712 may be executed that determines whether or not a file is defined. Cases where decisional operation 2712 evaluates to yes (e.g., “true”) a further series of operations 2718 may be executed. In example cases where decisional operation 2712 evaluates to no, further operations 2719 may be executed. In certain cases these various operations associated with the engine tier 2703 may be executed. For example, in some embodiments, an operation 2719 may be executed that gets a record definition property.

In some example embodiments, once this record definition property is retrieved from the database tier 2704, a decisional operation 2722 may be executed that determines whether or not a record definition property for a particular advertiser is scheduled to run. Cases where decisional operation 2722 evaluates to yes (e.g., “true”) a further decisional operation 2724 may be executed. In example cases where decisional operation 2722 evaluates to false, no further actions are taken. In example cases where a decisional operation 2724 is executed and the host has verified and determined whether or not it is locked, and in cases where that decisional operation 2724 evaluates to yes (e.g., “true”), a further operation 2725 is executed that builds a file path for each active or locked record definition. During the course of building this file path, an operation 2723 may be executed that uses verified host information and standard naming conventions such as, for example, advertised name, product ID, primary flag, and other associated types or standard naming conventions to build this file path and to denote various record definitions. In example cases where operation 2725 has successfully executed, an operation 2728 is executed that in effect gets the data in the form of the transaction data 109 from, for example, the network appliance 108. Once operation 2728 is successfully executed and a job is generated, an operation 2729 is executed that gets a record definition style sheet. Once this record definition style sheet is obtained or retrieved from, for example, a database, a decisional operation 2730 is executed that determines whether or not the retrieved record definition style sheet is a test file. Cases where decisional operation 2730 evaluates to yes (e.g., “true”), future operation for further operations 2731 are executed. In example cases where decisional operation 2730 evaluates to no (e.g., “false”) future further operations 2732 are executed. Residing as a part of the database tier 2704 is a number of types of data. For example, shown is data including data 2733 in the form of product host schedule and primary and secondary attribute data. Further, this data is elaborated on through, for example, explanation 2734, wherein the host may, for example, contain data relating to whether or not the host is locked, and whether the target path and test file name were verified, yes or no. Also, “schedule” may be further elaborated on in terms of whether or not the schedule is enabled, a start date, an end date, and a run time, where this run time may be, for example, some type of run time denoted by a time zone such as CST, Pacific Standard Time (PST), Eastern Standard Time (EST), or some other suitable time zone. In some example embodiments, a run time based upon Greenwich Mean Time (GMT) may be implemented. Further frequency of the schedule data is also denoted, where this frequency may include dates such as Monday, Wednesday, Friday or some other suitable frequency. Also, record attributes may include, for example, whether the record attribute is locked, where it needs a display header, file extension, a row field delimiter, a line terminator, a text or quoted identifier, a pad character identifier or type, or a credit card validation value. Various data explained within explanation 2734 may be inputted utilizing, for example, the interface described in FIG. 5.

In some example embodiments, the engine tier 2703 picks up and runs continuously, and checks to see for which products a fulfillment file 110 is to be generated. Once a fulfillment file 110 is identified (see e.g., decisional operation 2722), then a determination is made as to whether the record definition is active and locked (see e.g., decisional operation 2720). Further, the host 114 is verified and locked (see e.g., operation 2724). Then, in some example embodiments, the engine tier 2703 begins the process of building the file or the path to write the file (see e.g., operation 2725). In some example embodiments, operation 2728 is executed to create a job for that advertiser product and definition. The operation 2729 may then get record definition style sheets and make a determination as to whether the style sheet is a test file (see e.g., decisional operation 2730). In some example embodiments, a style sheet contains formatting instructions based upon the record definition XSL 2000. This style sheet is used to format the transaction data 109 and to generate a fulfillment file 110.

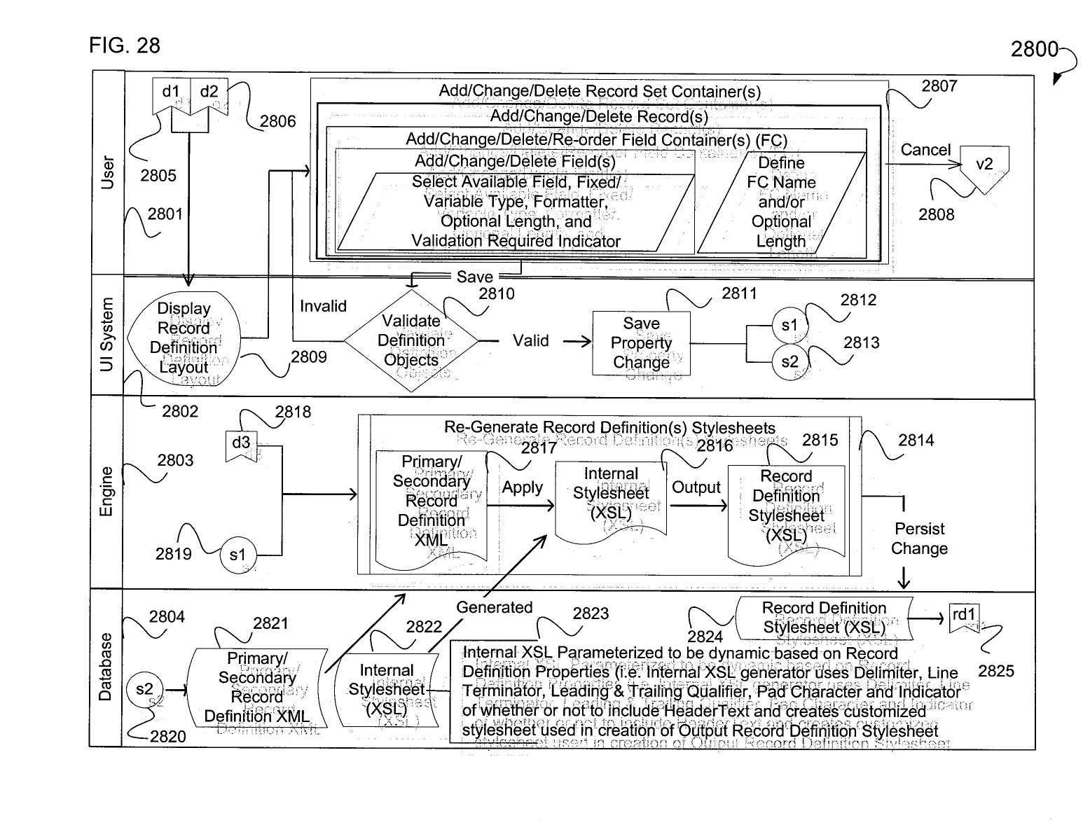

FIG. 28 is a flowchart illustrating example method 2800 used to execute operations 2717 and 2718, herein referenced as 2805 and 2806, respectively. As with FIGS. 26 and 27, FIG. 28 is divided into a number of tiers that are common to the three tier architecture common within the software arts. Shown is an interface tier referenced as user tier 2801, a logic tier referenced as a UI system tier 2802, an engine tier 2803, and a database tier 2804. Contained within each one of these tiers is a number of operations. These operations include, for example, the previously referenced operations 2805 and 2806 and a description of various operations that may be a part of the user tier 2801, referenced herein collectively as operations 2807. Further, an additional future operations 2808 is also shown. Residing as a part of the tiers 2802 and 2803 are a number of operations. For example, an operation 2809 is shown, a decisional operation 2810, an operation 2811, and various future operations 2812 and 2813. Further, various future operations 2818 and 2819 are also shown. Additionally, a collection of operations are depicted in 2814, where this collection of operations includes operation 2817, 2816, and 2815. Further, within the database tier 2804 a number of types of data are displayed, including for example data 2821, 2822, 2823, 2824, and future operations 2825 and 2820.

In some example embodiments, an operation 2805 and 2806 are executed so as to execute an operation 2809 that displays a record definition layout (see e.g., FIG. 5). Once displayed, operation 2807 is executed, which allows for the user 201 to perform a number of operations (e.g., user operations) on the record definition that is displayed. These user operations include, for example, adding, changing, or deleting a record set container; adding, changing, or deleting records contained within these records of container; adding, changing, or deleting re-order field contained within the records; and adding, changing, or deleting various fields associated with record definition containers. These user operations may be performed wherein a user 201 may be able to, for example, select an available field, fixed variable type, format, or length that require validation for a particular field. Further, user 201 may be able to, for example, define a record definition container name, or a length for a record definition container wherein length is in terms of characters. Additionally, user 201, through utilizing an interface, may be able to engage in various future actions via the executions of the operation 2808. In certain example cases, where any one of the functions displayed as a part of the operation 2807 is executed, a further decisional operation 2810 may be executed that may serve to validate certain definition objects. In example cases were decision operation 2810 is executed, a validated command is sent to an operation 2811 wherein for example this validated command is equivalent to the decisional operation 2810 evaluating to true.

In example cases where operation 2811 is executed, future operation 2812 and 2813 may be executed. Further, as a part of the engine tier level 2803 a number of operations may be executed so as to engage in the translation of XML such that an internal XSL 1900 is taken and applied to a record definition XML 208. Once record definition XSL 2000 is applied to the record definition XML 208 a record definition XSL 2000 is generated. This record definition XSL 2000 is then applied to transaction data 109 to generate the fulfillment file 110. Displayed within the engine tier 2803 is a re-generate record definition style sheets operation 2814. This operation 2814 is generated as a result of the execution of operation 2818 and 2819. Contained within this operation 2814 are a number of sub-operations including for example the execution of operation 2817 that generates a primary or secondary record definition XML. This primary or secondary record XML is then applied to an internal style sheet via the execution of operation 2816, the result of which is an output in the form of a record definition style sheet XSL as denoted through the execution of operation 2815. In some cases during the execution of these various operations 2815 through 2817, a number of database queries (e.g., SQL-based queries) are generated or made such that, for example, an operation 2820 is executed that generates a primary or secondary record definition XML 2821. It is then provided to the operation 2817. Further, an internal XSL style sheet 2822 is generated and provided to an operation 2816. This internal style sheet 2822 may contain information including, as denoted in operation 2823, internal XSL parameters to be dynamic based upon record definition properties. Further, a record definition style sheet XSL 2824 may be generated and may provide future operation 2825.

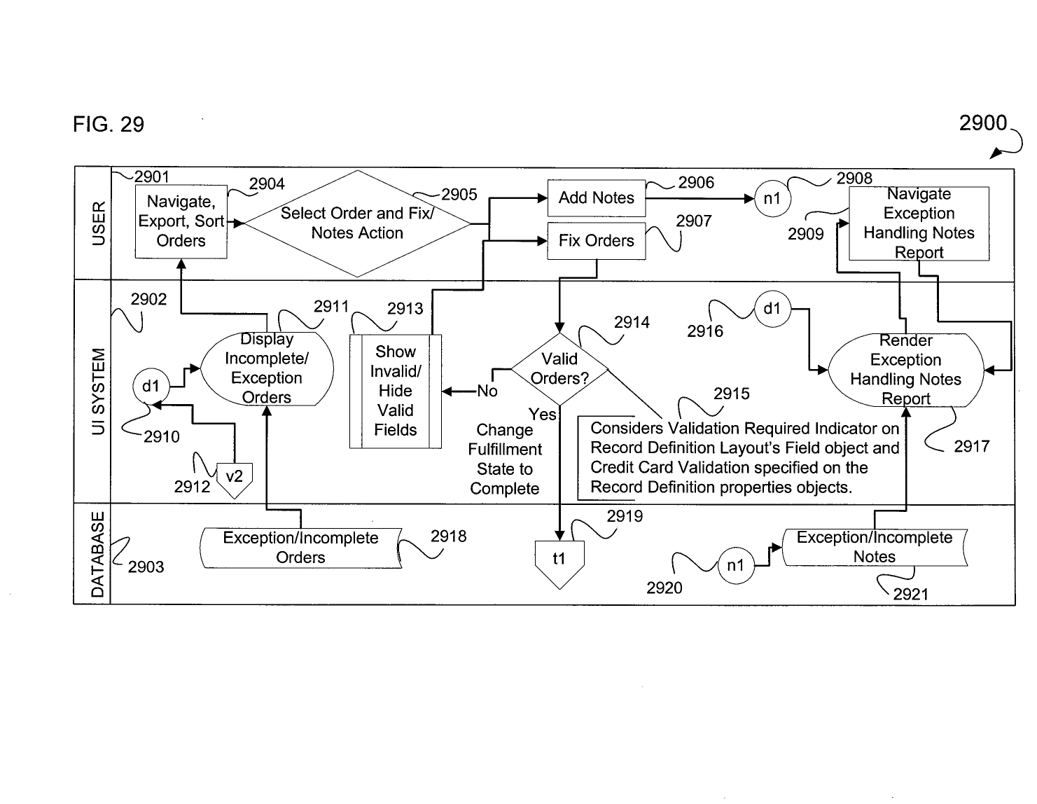

FIG. 29 is a flowchart illustrating example method 2900 to retrieve orders for which an exception exists. Shown is a method 2900 containing a number of operations where these operations can be divided in terms of the three tier software architecture. A first tier is shown relating to an interface tier wherein this first tier is referenced as user tier 2901. Next, a second tier is shown wherein the second tier relates to a logic tier referenced herein as a UI system tier 2902. Further a database or storage tier is illustrated wherein this database storage tier relates to a database tier 2903. Contained in each one of these tiers is any one of a number of operations; for example, the user tier 2901 contains operations 2904 through 2909. The UI system tier 2902 contains operations 2910 through 2917. The database tier 2903 contains operations 2918 through 2921. Starting with the user tier 2901, an operation 2904 may be executed by the user 201 wherein this operation 2904 allows the user 201 to navigate, export, or sort orders such as order 105. Next, a decisional operation 2905 may be executed that allows the user 201 to select orders and fix notes to these orders. Once operation 2905 evaluates to true, operations 2906 and 2907 are executed. Operation with regard to operation 2906, through the execution of this operation the user is allowed to add notes to a record. On successful execution of operation 2906 future operation 2908 may be executed. Upon the successful completion of operation 2907, a decisional operation 2914 may be executed. Additionally residing as part of user tier 2901 is an operation 2909 that allows an user 201 to navigate exception handling or notes reports through, for example, tabbing on these exception handling or notes reports through utilizations of some type of which are the object to this previously denoted or referenced. With regard to the UI system tier 2902, a number of operations are shown. For example, via the execution of operation 2910, incomplete or exception orders are displayed through the execution of operation 2911. This operation 2910 may roughly correspond to the previously referenced operation 2717. Once these incomplete orders or exception orders are displayed through the execution of operation 2911, a further operation 2904 is executed.

In certain example cases an additional operation 2913 is displayed as a part of the UI system tier 2902. This operation 2913 may be executed as a result of the previously referenced decisional operation 2914 evaluating to no (e.g., “false”). Once operation 2913 is executed, the previously referenced operations 2906 and 2907 may also be executed or, in certain circumstances, re-executed. In example cases where decisional operation 2914 evaluates to yes (e.g. “true”) future operations 2919 may be executed. At explanation 2915 an explanation is provided of the execution of decisional operation 2914. In certain circumstances, future operations 2916 may be executed wherein these operations 2916 roughly correspond to the previously referenced operations 2717. Future operations 2916 result in the execution of an operation 2917 that renders exception handling notes and reports. This rendering of exception handling notes and reports is provided through the execution of operation 2917, and results from the previous execution of operation 2909. In certain circumstances for the successful execution various operations contain the user tier 2901 or the UI system tier 2902 to be executed various types to data must be retrieved through the execution of operations and/or retrieval of data contained within the database level or tier 2903. For example an operation 2918 may be executed that will provide exception or incomplete order information to the operation 2911. Further, upon the successful completion of the execution of decisional operation 2914, a future series of operations 2919 may be executed. Also, in certain instances, through the execution of operation 2917 various data as referenced at 2921 may be retrieved, where this data includes, for example, exceptions or incomplete notes. This various data may be prompted to be provided to the operation 2917 through the execution of various operations 2920.

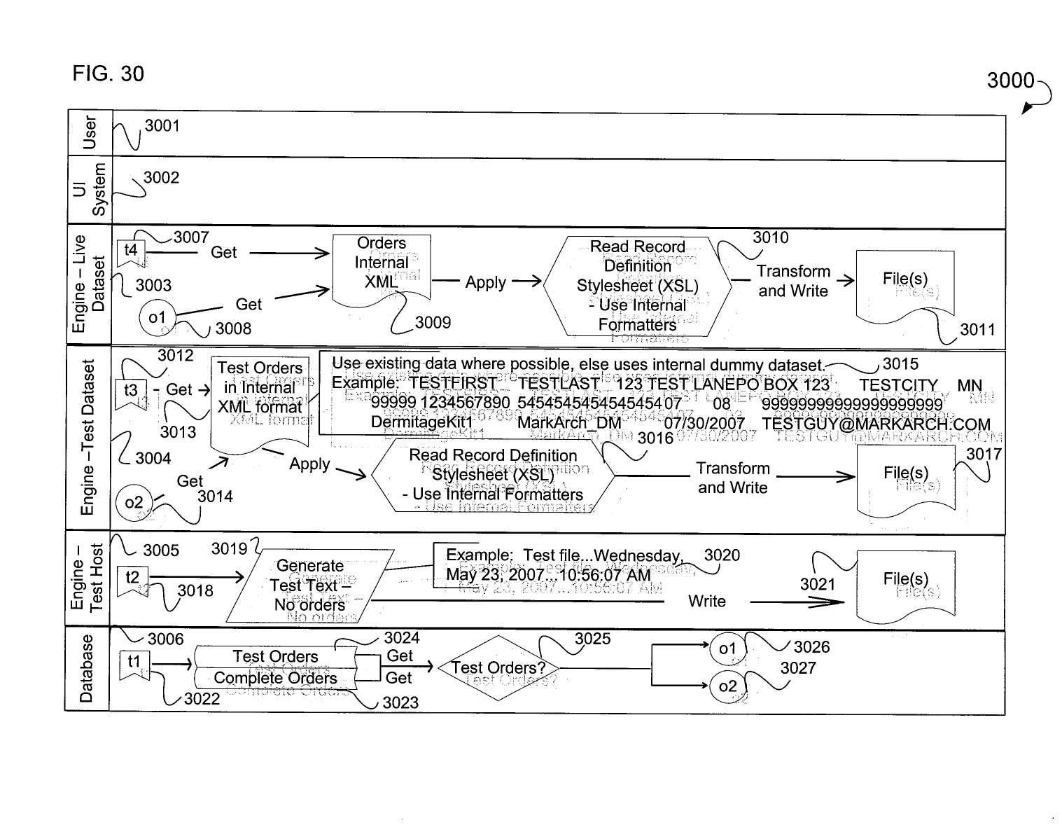

FIG. 30 is a flowchart illustrating an example method 3000 used to illustrate a number of operations associated with the execution of the previously referenced engine tier 2703. In some example embodiments, a three tier software architecture is used to illustrate the execution of various levels associated with the methods disclosed herein. For example, a logic level or tier may be sub-divided into an engine live dataset tier 3003, an engine test dataset tier 3004, and an engine test host dataset tier 3005. Further, a database tier 3006 is also shown. Also depicted are a user tier 3001 and a UI system tier 3002. Starting with the engine live dataset tier 3003, a number of operations are shown to exist or be a part of this tier, including for example operations 3007 through 3011. Residing as a part of the engine test dataset tier 3004 are a number of operations, including for example operations 3012 through 3017. Residing as a part of the engine test host tier 3005 are a number of operations, including operations 3018 through 3021. Further, the database tier 3006 may itself contain a number of operations, including for example operations 3022 through 3027.

In some example embodiments, with regard to the engine live dataset tier 3003, operations 3007 and 3008 may be executed wherein these operations, for example, may get various internal XML files 3009, and wherein these internal XML files 3009 contain information relating to orders. Similarly, these internal XML files 3009 may be obtained through the execution of the operation associated with the engine test data set tier 3004. Once operations 3007 or 3008 are executed and the order internal XML files 3009 retrieved, this order internal XML 3009 files may be mapped to a record definition XSL in operation 3010, which then may generate various files, where this record definition XSL may roughly correspond to the previously referenced record definition XSL 2000 which may then be used to transform and write any one of a number of fulfillment files 110 referenced here as files 3011. In some example embodiments various operations residing as a part of the engine test dataset tier 3004 may be shown. For example, operations 3012 may be executed to get various test orders that are formatted in XML. These test orders are referenced as test orders 3013. These test orders may then be elaborated on through an elaboration operation 3015 wherein these test orders may use existing data were possible or may even use internal dummy testing data. Further, these tests orders 3013 may be applied to a record definition style sheet operation 3016 where the record definition style sheet may relate to or be similar to the record definition XSL 2000. Through using this record definition XSL 2000 and applying it to the test orders or internal XML format, one may transform and write any one of a number of fulfillment files referenced herein as 3017 and referenced elsewhere are fulfillment files 110. In some example embodiments, an engine test host tier 3005 is shown wherein a number of operations 3018 may be executed that may then result in the generation of a test text operation 3019, where this test text may contain a descriptor 3020, and where this descriptor as shown here made a note for the test file, the time of the week, the date and time the test file was created. Then various test files may be generated through a write operation where these test files may be referenced herein as files 3021. A database tier 3006 may be shown as well wherein various operations 3022, 3023, and 3024 may then get the test orders through the execution of decisional operation 3025. In cases where decisional operation 3025 evaluates to true, future operations 3026 and 3027 may be executed.

### Example Database

Some embodiments may include the various databases (e.g., 113, 2305, 2310, and 2314) being relational databases, or in some cases OLAP-based databases. In the case of relational databases, various tables of data are created and data is inserted into and/or selected from these tables using SQL or some other database-query language known in the art. In the case of OLAP databases, one or more multi-dimensional cubes or hypercubes containing multidimensional data may be implemented, which data may be selected from or inserted into using MDX. In the case of a database using tables and SQL, a database application such as, for example, MYSQL™, SQLSERVER™, Oracle 81™, 10G™, or some other suitable database application may be used to manage the data. In the case of a database using cubes and MDX, a database using Multidimensional On Line Analytic Processing (MOLAP), Relational On Line Analytic Processing (ROLAP), Hybrid Online Analytic Processing (HOLAP), or some other suitable database application may be used to manage the data. These tables, or cubes made up of tables in the case of, for example, ROLAP, are organized into an RDS or Object Relational Data Schema (ORDS), as is known in the art. These schemas may be normalized using certain normalization algorithms so as to avoid abnormalities such as non-additive joins and other problems. Additionally, these normalization algorithms may include Boyce-Codd Normal Form or some other normalization or optimization algorithm known in the art.

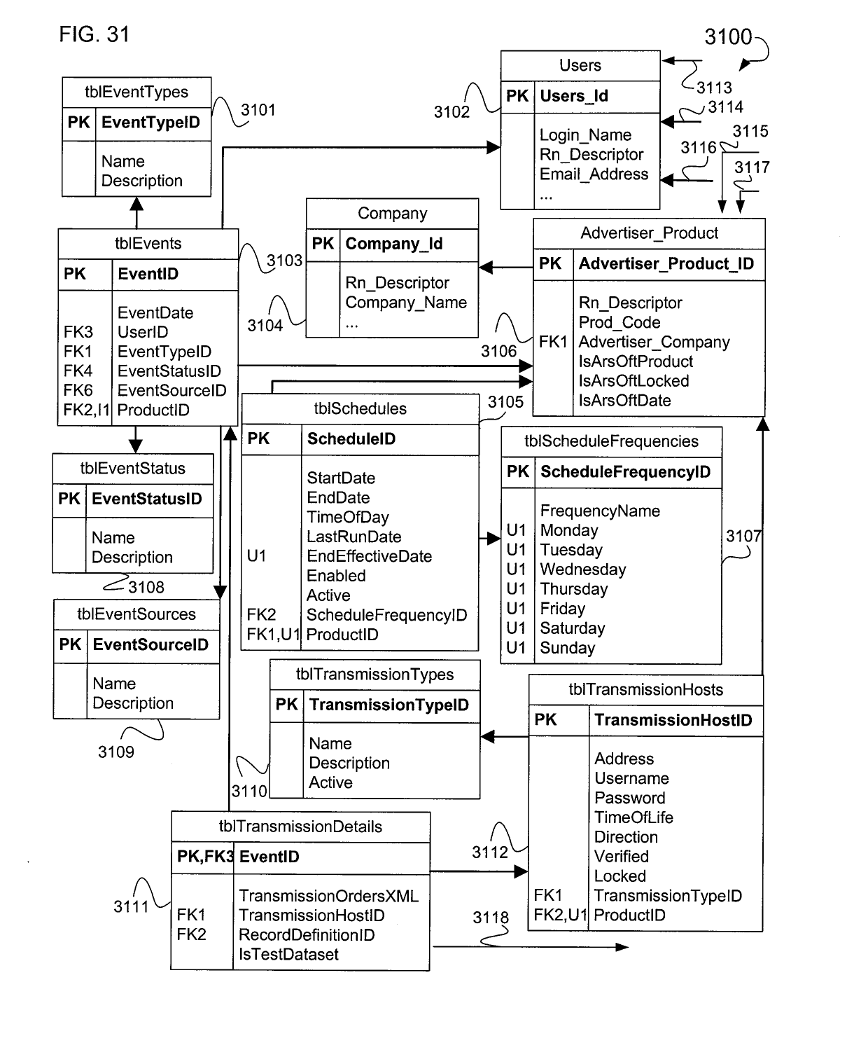

FIG. 31 is an example relational data schema (RDS) 3100. Contained in this RDS 3100 are a number of database tables relating to data that may be stored within, for example, the previously referenced order database 113. These tables include a “Table Event Types” Table 3101 that contains, amongst other things, an event type ID and the name and description of an event. Further, a Table 3102 titled “Users” is also shown that contains various user ID information such as, for example, a log in name, an email address, and a named descriptor for a particular user. Further, a Table 3103 is shown titled “Table Events” that contains various events related to a table. These events may include an event user ID, an event type ID, event status ID, event source ID, a product ID. Further, a Table 3104 is shown entitled “Company” that contains information in a particular company wherein information includes a company name and a routine descriptor. Also, a Table 3105 titled “Table Schedules” is shown and contains information relating to the schedules based upon which a particular transaction data 109 may be retrieved from a network appliance. In some example embodiments this Table 3105 places schedules pertaining to the time, date, and scheduling information based upon which a fulfillment file110 may be retrieved from a database server 112 and ultimately from the order database 113. The brief data contained within Table 3105 includes, for example, a start date, end date, time of day, last run date, end effective date, enable date, active date, schedule frequency ID, and a product ID.

In some example embodiments, Table 3106, titled “Advertiser Product,” is also shown that relates to advertiser products, wherein the data contained within this Table 3106 include a product code, an advertiser company, and various information relating to a particular product, such as whether the data pertaining to the product is locked or otherwise modifiable or unmodifiable in the advertiser company information product code. Also, a Table 3107, titled “Schedule Frequencies,” is shown where this Table 3107 relates to the schedule of frequencies, where this frequency may be fixed in terms of days of the week that a fulfillment file 110 or transaction data 109 may be retrieved from the respective devices contained within this Table 3107 are the days of the week (e.g., Monday, Tuesday, Wednesday, Thursday, and Friday). Also shown is a Table 3108, “Event Status,” relating to event status. Contained within this Table 3108 is the name and description of an event. Table 3109, “Event Source,” is also shown. This table 3109 relates to event sources where the sources include the name and description of the source of an event. A Table 3110, “Transmission Types,” is also shown that denotes various transmission types. These transmission types may include names, descriptions, and whether or not the transmission type is active. A Table 3111, “Transmission Details,” is also shown that contains transmission details. These transmission details may include whether the transmission orders XML, the post ID, the record definition ID, and the test data sets. A Table 3112 is also shown. This Table 3112, titled “Transmission Host,” contains transmission host ID information, including the address, user name, password, time of life of the transmission, host ID, direction, verified, locked, transmission type ID, and product ID. Connecting these various tables are various types of relationships to other tables contained within the RDS 3100 or to tables contained in other RDSs as will be more fully described below. For example, relationships 3113 through 3118 are shown where these relationships relate to an RDS 3200 as will be more fully described below.

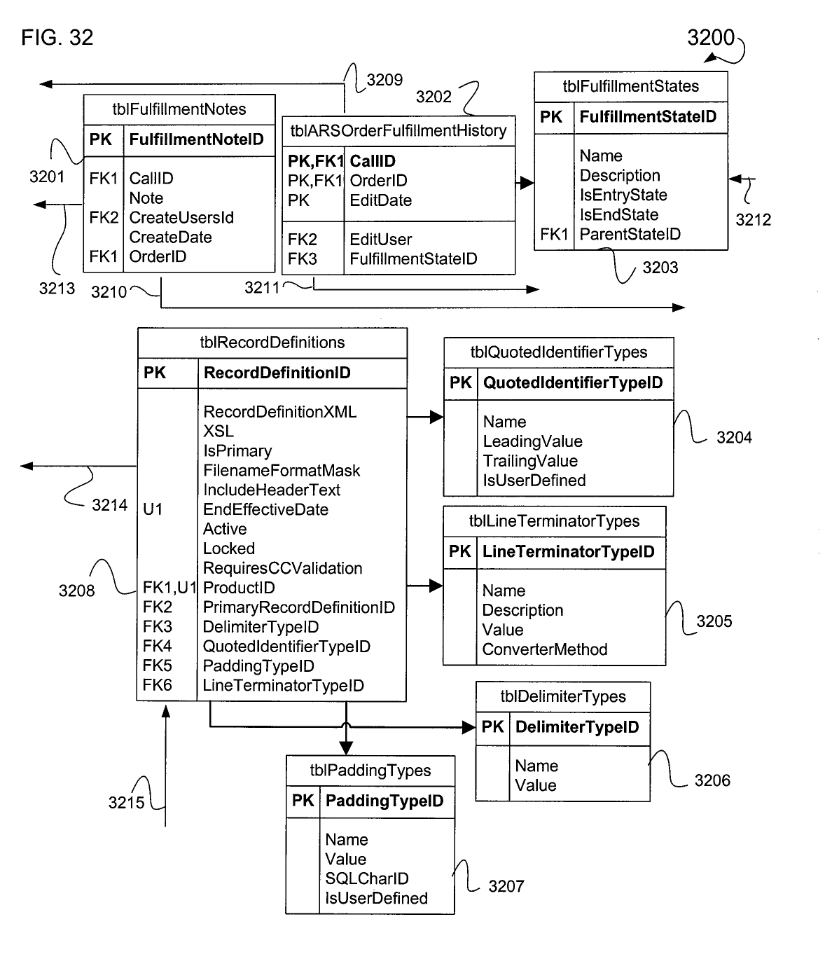

FIG. 32 is an RDS 3200. Contained within this RDS 3200 are a variety of tables. For example, Table 3201 relates to fulfillment notes where these fulfillment notes include, for example, a call ID, a note value, a created user ID, a create date ID, and an order ID. Further, a Table 3202 is shown that contains an order fulfillment history where the order fulfillment history may include, for example, a call ID, an order ID, and an edit date. Additionally, edit user and performance data may also be included in the Table 3202. Also shown is a Table 3203 that contains various fulfillment dates. These various fulfillment states include for example the name of the state, the description of the state, an entry state, an end state, and the parent state ID value. A Table 3204 is also shown that contains a quoted identifier type where this quoted identifier type includes, for example, a name, a leading value, a trailing value, and user defined value. Table 3205 is also shown that contains various line terminator types where the line terminator types include the name, description, value, and converter method relating to a particular line terminator type. A Table 3206 is also shown that contains a delimiter type where the delimiter type includes for example the name and value of the delimiter type. A Table 3207 is also shown where this Table 3207 contains padding types. The padding types include the name of the type, the value of the type, a character ID for the type, and whether or not the type is user defined. A Table 3208 is also shown and relates to record definitions wherein these record definitions include a record definition XML, a record definition XSL, whether or not the record definition is primary, a file name format mask for the record definition, include header text for the record definition, an end effective date for the record definition, whether the record definition is active, locked or requires CC validation, a product ID, primary record definition ID, a delimiter type ID, a quoted identifier type ID, a padding ID, and a line terminator ID. As with the RDS 3100, this RDS 3200 also has relationships to a number of other tables contained within, for example, the RDS 3100. For example, relationship 3214 is shown. A relationship 3215 is also shown. Relationships 3212, and 3213 are shown as are relationships 3211 and 3210.

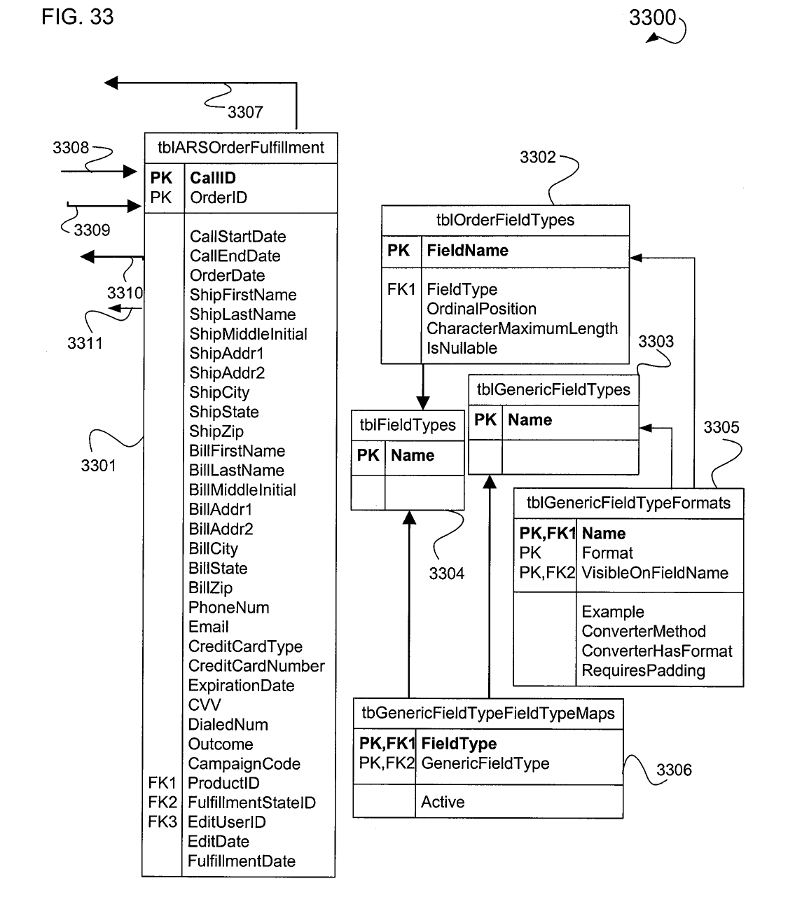

FIG. 33 is an RDS 3300. Contained within this RDS 3300 are a number of example tables including, for example, a table 3301 titled “Order Fulfillment,” which includes, for example, various types of data types pertaining to order fulfillment or, more specifically, data descriptions (and not data types) pertaining to order fulfillment, including call start date, call end date, order date, ship first name, ship last name, ship middle initial, shipping address1, shipping address2, ship city, ship state, ship zip, bill first name, bill last name, bill middle initial, bill address1, bill address2, bill city, bill state, bill zip, phone number, email, credit card type, credit card number, expiration date, CVV value, dialed number, outcome, campaign code, product ID, performance date ID, edit user ID, edit date, and fulfillment date. Also shown is a Table 3302 titled “Order Field Types.” These order field types may include a field type, an ordinal position, character maximum length, and an is null value. Further shown is a table 3303 that contains generic field types where these generic field types may be any one of a number of suitable data types. A table 3304 is also shown that contains field type values, where these field types may be anyone of a number of suitable data types. Also shown is table 3305 that contains various generic field type formats including, for example, the name of the actual format description, a visible field name, an example converter method, converter has format, and requires padding values. Table 3306 is also shown that contains generic field type maps containing, for example, a field type, and a generic field type, as with the other RDSs previously disclosed (e.g., RDS 3100, RDS 3200). A number of relationships are shown to the tables contained within the RDS 3300. These relationships include relationships 3308 through 3311.

Some example embodiments may include the previously referenced relationships 3113 through 3118, 3209 through 3212, 3214 and 3215, and 3307 though 3311. As to relationships 3113 through 3118, relation 3113 relates Table 3202. Relationship 3114 relates Table 3301. Relationship 3115 relates Table 3301. Relationship 3116 relates Table 3201. Relationship 3117 relates Table 3208. Relationship 3118 relates Table 3208. Relationship 3209 relates Table 3102. Relationship 3210 relates Table 3301. Relationship 3211 relates Table 3301. Relationship 3212 relates Table 3301. Relationship 3214 relates Table 3106. Relationship 3215 relates Table 3111. Relationship 3307 relates Table 3203. Relationship 3308 relates Table 3102. Relationship 3309 relates Table 3201. Relationship 3310 relates Table 3102. Relationship 3311 relates Table 3106.

In some example embodiments, the various RDSs 3100 through 3300 utilize any one of a number of suitable data types. These suitable data types may include, for example, a string flow integer, Binary Large Object (BLOB), Character Large Object (CLOB), a Boolean, a date data type, an XML data type, or some other suitable data types. These various data types may be utilized in conjunction with any one of the previously described tables in RDSs 3100 through 3300, and may be applied based upon the descriptor used to describe the values contained within each one of the tables or may be applied without the need for undue experimentation by one of skill in the art. For example, by way of illustration, the table 3101 may utilize a string for the name value and a string for the description value. Further, in some example embodiments, any type of descriptor that uses an ID value may utilize an integer or some other suitable numeric data type. Further, descriptors that utilize, for example, the word ‘is’ may utilize some type of Boolean data type. Additionally, descriptors that contain the words XML or XXL may utilize an XML data type. Further, any type of descriptor that utilizes the word maximum/minimum may utilize some type of integer data type. In some example embodiments, one of skill in the art may know how to implement any one of the tables described in RDSs 3100 through 3300.

### A Three-Tier Architecture

In some embodiments, a method is described as implemented in a distributed or non-distributed software application designed under a three-tier architecture paradigm, whereby the various components of computer code that implement this method may be categorized as belonging to one or more of these three tiers. Some embodiments may include a first tier as an interface (e.g., an interface tier) that is relatively free of application processing. Further, a second tier may be a logic tier that performs application processing in the form of logical/mathematical manipulations of data inputted through the interface level, and communicates the results of these logical/mathematical manipulations to the interface tier and/or to a backend, or storage, tier. These logical/mathematical manipulations may relate to certain business rules, or processes that govern the software application as a whole. A third tier, a storage tier, may be a persistent or non-persistent storage medium. In some cases, one or more of these tiers may be collapsed into another, resulting in a two-tier or even a one-tier architecture. For example, the interface and logic tiers may be consolidated, or the logic and storage tiers may be consolidated, as in the case of a software application with an embedded database. This three-tier architecture may be implemented using one technology, or, as will be discussed below, a variety of technologies. This three-tier architecture, and the technologies through which it is implemented, may be executed on two or more computer systems organized in a server-client, peer to peer, or some other suitable configuration. Further, these three tiers may be distributed between more than one computer system as various software components.

### Component Design

Some example embodiments may include the above described tiers, and processes or operations that make them up, as being written as one or more software components. Common too many of these components is the ability to generate, use, and manipulate data. These components, and the functionality associated with each, may be used by client, server, or peer computer systems. These various components may be implemented by a computer system on an as-needed basis. These components may be written in an object-oriented computer language such that a component oriented, or object-oriented programming technique can be implemented using a Visual Component Library (VCL), Component Library for Cross Platform (CLX), Java Beans (JB), Enterprise Java Beans (EJB), Component Object Model (COM), Distributed Component Object Model (DCOM), or other suitable technique. These components may be linked to other components via various Application Programming Interfaces (APIs), and then compiled into one complete server, client, and/or peer software application. Further, these APIs may be able to communicate through various distributed programming protocols as distributed computing components.

### Distributed Computing Components and Protocols

Some example embodiments may include remote procedure calls being used to implement one or more of the above described components across a distributed programming environment as distributed computing components. For example, an interface component (e.g., an interface tier) may reside on a first computer system that is located remotely from a second computer system containing a logic component (e.g., a logic tier). These first and second computer systems may be configured in a server-client, peer-to-peer, or some other suitable configuration. These various components may be written using the above-described object-oriented programming techniques, and can be written in the same programming language or in different programming languages. Various protocols may be implemented to enable these various components to communicate regardless of the programming language(s) used to write them. For example, a component written in C++ may be able to communicate with another component written in the Java programming language through use of a distributed computing protocol such as a Common Object Request Broker Architecture (CORBA), a Simple Object Access Protocol (SOAP), or some other suitable protocol. Some embodiments may include the use of one or more of these protocols with the various protocols outlined in the OSI model or the TCP/IP protocol stack model for defining the protocols used by a network to transmit data.

### A System of Transmission Between a Server and Client

Some embodiments may utilize the OSI model or TCP/IP protocol stack model for defining the protocols used by a network to transmit data. In applying these models, a system of data transmission between a server and client, or between peer computer systems, is described as a series of roughly five layers comprising: an application layer, a transport layer, a network layer, a data link layer, and a physical layer. In the case of software having a three-tier architecture, the various tiers (e.g., the interface, logic, and storage tiers) reside on the application layer of the TCP/IP protocol stack. In an example implementation using the TCP/IP protocol stack model, data from an application residing at the application layer is loaded into the data load field of a TCP segment residing at the transport layer. This TCP segment also contains port information for a recipient software application residing remotely. The TCP segment is loaded into the data load field of an IP datagram residing at the network layer. Next, the IP datagram is loaded into a frame residing at the data link layer. The frame is then encoded at the physical layer, and the data is transmitted over a network such as an internet, Local Area Network (LAN), Wide Area Network (WAN), or some other suitable network. In some cases, the term internet refers to a network of networks. These networks may use a variety of protocols for the exchange of data, including the aforementioned TCP/IP as well as ATM, SNA, SDI, or some other suitable protocol. These networks may be organized within a variety of topologies (e.g., a star topology) or structures.

### Example Computer System

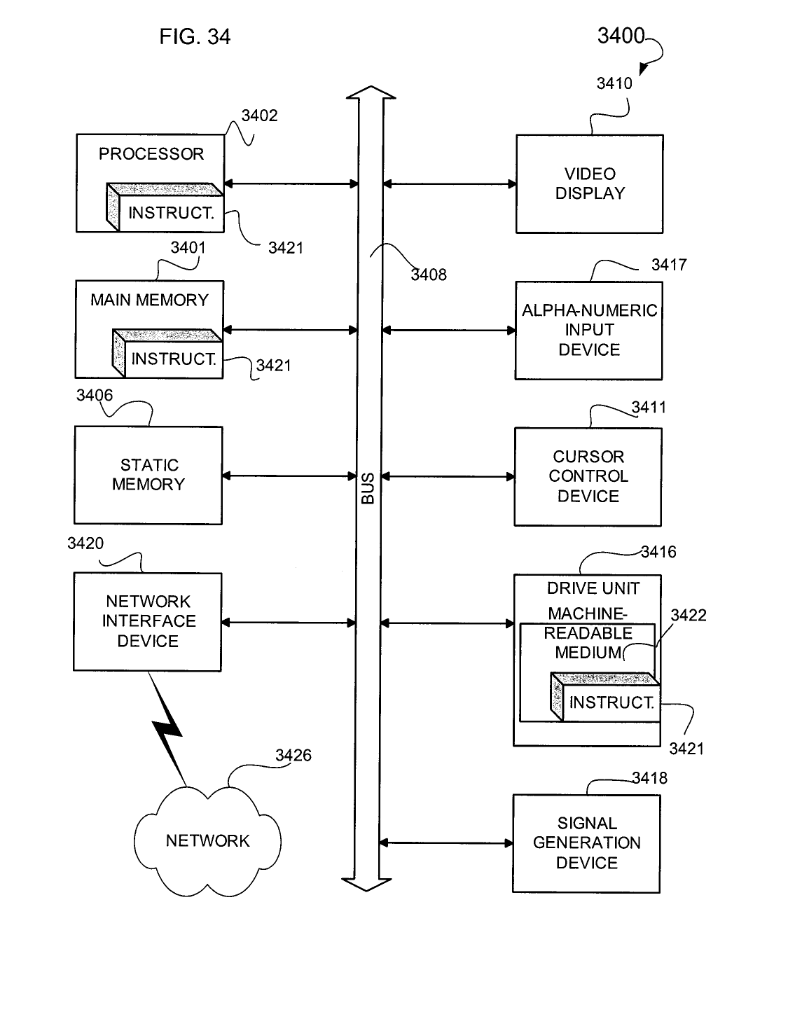

FIG. 34 shows a diagrammatic representation of a machine in the example form of a computer system 3400 that executes a set of instructions for causing the machine to perform any one or more of the methodologies discussed herein. In alternative embodiments, the machine may operate as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a Personal Computer (PC), a tablet PC, a Set-Top Box (STB), a PDA, a cellular telephone, a web appliance, a network router, IVR switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Example embodiments can also be practiced in distributed system environments where local and remote computer systems that are linked (e.g., either by hardwired, wireless, or a combination of hardwired and wireless connections) through a network both perform tasks such as those illustrated in the above description.

The example computer system 3400 includes a processor 3402 (e.g., a Central Processing Unit (CPU), a Graphics Processing Unit (GPU) or both), a main memory 3401 and a static memory 3406, which communicate with each other via a bus 3408. The computer system 3400 may further include a video display unit 3410 (e.g., a Liquid Crystal Display (LCD) or a Cathode Ray Tube (CRT)). The computer system 3400 also includes an alphanumeric input device 3417 (e.g., a keyboard), a User Interface (UI) cursor controller device 3411 (e.g., a mouse), a disk drive unit 3416, a signal generation device 3418 (e.g., a speaker), and a network interface device (e.g., a transmitter) 3420.

The disk drive unit 3416 includes a machine-readable medium 3422 on which is stored one or more sets of instructions 3421 and data structures (e.g., software) embodying or utilized by any one or more of the methodologies or functions illustrated herein. Software (e.g., instructions 3421) may also reside completely or at least partially within the main memory 3401 and/or within the processor 3402 during execution thereof by the computer system 3400, the main memory 3401 and the processor 3402 also constituting machine-readable media.

The instructions 3421 may further be transmitted or received over a network 3426 via the network interface device 3420 utilizing any one of a number of well-known transfer protocols (e.g., HTTP, Session Initiation Protocol (SIP)).

The term “machine-readable medium” should be taken to include a single medium or multiple media (e.g., a centralized or distributed database, and/or associated caches and servers) that stores the one or more sets of instructions. The term “machine-readable medium” shall also be taken to include any medium that is capable of storing, encoding, or carrying a set of instructions for execution by the machine and that causes the machine to perform any of the one or more of the methodologies illustrated herein. The term “machine-readable medium” shall accordingly be taken to include, but not be limited to, solid-state memories, optical and magnetic media, and carrier wave signals.

### Marketplace Applications

In some example embodiments, a system and method is shown that allows for the translation of transaction data 109 into a fulfillment file 110 that is formatted based upon the needs of the advertiser 209. In some example embodiments, the system and method shown herein is robust and scaleable to the point that a variety of advertisers' formatting needs may be met, without the need for the custom writing of computer code to meet these formatting needs. In some example embodiments, the user 201 may select the characteristics of a record definition container based upon a file provided by the advertiser 209. This file may instruct the user 201 as to the needs and requirements of the advertiser 209. Further, using one or more of the interfaces illustrated herein, a record definition container and accompanying record definition fields contained within this container may be modified to meet the changing needs of the advertiser 209. In some example embodiments, these needs are met through the translation of the transaction data 109.

It is to be understood that the above description is intended to be illustrative and not restrictive. Although numerous characteristics and advantages of various embodiments as illustrated herein have been set forth in the foregoing description, together with details of the structure and function of various embodiments, many other embodiments and changes to details may be apparent to those of skill in the art upon reviewing the above description. The scope of the invention should be, therefore, determined with reference to the appended claims, along with the full scope of equivalents to which such claims are entitled. In the appended claims, the terms “including” and “in which” are used as the plain-English equivalents of the respective terms “comprising” and “wherein,” respectively. Moreover, the terms “first,” “second,” and “third,” etc., are used merely as labels and are not intended to impose numerical requirements on their objects.

The Abstract of the Disclosure is provided to comply with 37 C.F.R. §1.72(b), requiring an abstract that may allow the reader to quickly ascertain the nature of the technical disclosure. It is submitted with the understanding that it may not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A computer-implemented method comprising:
generating a translation rule file describing a first rule to be used to translate a record definition file;
mapping the record definition file, using the first rule, to generate a record definition rule file describing a second rule used to translate transaction data; and
transforming the transaction data, using the second rule, to generate a fulfillment file.

2. The computer-implemented method of claim 1, wherein the first rule is written in an eXtensible Markup Language (XML) and describes a data type.

3. The computer-implemented method of claim 2, wherein the data type includes a description of a mapping from a first data type to a second data type.

4. The computer-implemented method of claim 1, wherein the record definition file is written in an eXtensible Markup Language (XML) and describes a file format associated with a client.

5. The computer-implemented method of claim 4, wherein the file format associated with the client relates to a format used in describing at least one of a transaction in commerce, a client request data, and a consumer information data.

6. The computer-implemented method of claim 5, wherein the fulfillment file is formatted according to the file format associated with the client.

7. The computer-implemented method of claim 1, wherein the second rule is written in an eXtensible Markup Language (XML) and describes a data type conversion.

8. The computer-implemented method of claim 7, wherein the data type conversion includes at least one of concatenating at least two data fields, converting from a first data type to a second data type, and converting using a user-defined field.

9. The computer-implemented method of claim 1, wherein the fulfillment file is formatted with a format including at least one of an eXtensible Markup Language (XML) based format, a character delimited flat file format, and a fixed length file.

10. A computer system comprising:
a generator to generate a translation rule file describing a first rule to be used to translate a record definition file;
a mapping engine to map the record definition file, using the first rule, to generate a record definition rule file describing a second rule used to translate transaction data; and
a transformation engine to transform the transaction data, using the second rule, to generate a fulfillment file.

11. The computer system of claim 10, wherein the first rule is written in an eXtensible Markup Language (XML) and describes a data type.

12. The computer system of claim 11, wherein the data type includes a description of another mapping from a first data type to a second data type.

13. The computer system of claim 10, wherein the record definition file is written in an eXtensible Markup Language (XML), and describes a file format associated with a client.

14. The computer system of claim 13, wherein the file format associated with the client relates to a format used in describing at least one of a transaction in commerce, client request data, and consumer information data.

15. The computer system of claim 14, wherein the fulfillment file is formatted according to the file format associated with the client.

16. The computer system of claim 10, wherein the second rule is written in an eXtensible Markup Language (XML) and describes a data type conversion.

17. The computer system of claim 16, wherein the data type conversion includes at least one of concatenating at least two data fields, converting from one data type to a second data type, converting using a user-defined field.

18. The computer system of claim 10, wherein the fulfillment file is formatted with a format including at least one of an eXtensible Markup Language (XML) based format, a character delimited flat file format, and a fixed length file.

19. In a computer system having a Graphical User Interface (GUI) including a display and a selection device, a method of providing and selecting from a menu on the display, the method comprising:
retrieving a product list associated with a client, the list of products composed of at least one product associated with a widget, the widget including at least one of an expansion or a contraction widget; and
displaying the product list associated with the client, and the associated widget.

20. The computer system having the GUI including the display and the selection device of claim 19, further comprising:
retrieving a product overview related to a product associated with a client, the product overview including a product checklist frame; and
displaying the product overview including an event history for the product associated with the client.

21. The computer system having the GUI including the display and the selection device of claim 19, further comprising:
retrieving a record definition associated with the product, the record definition defining a data format of records associated with the product; and
displaying the record definition.

22. The computer system having the GUI including the display and the selection device of claim 19, further comprising:
retrieving a list of exceptions associated with an order relating to the product associated with a client, the list of exceptions including incomplete orders; and
displaying the list of exceptions.

23. The computer system having the GUI including the display and the selection device of claim 22, further comprising highlighting an exception that appears in the list of exceptions.

24. An apparatus comprising:
means for generating a translation rule file describing a first rule to be used to translate a record definition file;
means for mapping the record definition file, using the first rule, to generate a record definition rule file describing a second rule used to translate transaction data; and
means for transforming the transaction data, using the second rule, to generate a fulfillment file.

25. A machine-readable medium comprising instructions, which when implemented by one or more machines, cause the one or more machines to perform the following operations:
generating a translation rule file describing a first rule to be used to translate a record definition file;
mapping the record definition file, using the first rule, to generate a record definition rule file describing a second rule used to translate transaction data; and
transforming the transaction data, using the second rule, to generate a fulfillment file.
